(19) United States
(12) Patent Application Publication
(10) Pub. No.: US 2013/0083274 A1
(43) Pub. Date: Apr. 4, 2013

(54) CELLULOSE ACYLATE LAMINATE FILM AND ITS PRODUCTION METHOD, POLARIZER AND LIQUID-CRYSTAL DISPLAY DEVICE

(71) Applicant: FUJIFILM Corporation, Tokyo (JP)

(72) Inventors: Isao FUJIWARA, Kanagawa (JP); Hirofumi TOYAMA, Kanagawa (JP)

(73) Assignee: FUJIFILM CORPORATION, Tokyo (JP)

(21) Appl. No.: 13/630,742

(22) Filed: Sep. 28, 2012

(30) Foreign Application Priority Data
Sep. 30, 2011 (JP) 2011-216029

(51) Int. Cl. G02F 1/1335; B29C 69/02; B32B 23/08; G02B 5/30; B32B 7/02

(52) U.S. Cl. 349/96; 359/485.01; 428/213; 264/291

(57) ABSTRACT

A cellulose acylate laminate film containing a skin B layer that contains a cellulose acetate satisfying 2.50≦Z2<3.00 (Z2 means a total degree of acyl substitution) and a core layer that is thicker than the skin B layer and contains a cellulose acylate satisfying 2.00<Z1≦2.50 (Z1 means a total degree of acyl substitution), wherein the core layer and the skin B layer contain a retardation-controlling agent having refractive index anisotropy and the difference between the refractive index anisotropy measured on one surface of the film and the refractive index anisotropy measured on the other surface thereof is at most 0.0005.

### CROSS-REFERENCE TO RELATED APPLICATIONS

The present application claims the benefit of priority from Japanese Patent Application No. 2011-216029, filed on Sep. 30, 2011, the contents of which are herein incorporated by reference in their entirety.

### BACKGROUND OF THE INVENTION

1. Field of the Invention

The present invention relates to a cellulose acylate laminate film and its production method, and to a polarizer and a liquid-crystal display device. More precisely, the invention relates to a laminate film produced by cocasting a cellulose acylate having a low degree of substitution as the core layer thereof, and a method for producing the laminate film, and to a polarizer and a liquid-crystal display device.

2. Description of the Related Art

The performance to determine the display quality of liquid-crystal display devices includes a front contrast, a viewing angle contrast and a viewing angle color shift of the devices; and recently, further performance advances have become desired more and more. For increasing the viewing angle contrast and for evading the color shift in liquid-crystal display devices, used is a retardation film having a specific retardation value or a combination of such retardation films.

As the main material for the retardation film, it is known that a cellulose acylate is advantageous and that the optical characteristics of the film depend on the degree of acyl substitution of the cellulose acylate used and also on the type and the amount of the additive to be added to the film.

For example, Patent Reference 1 discloses an optical compensatory film having a different refractive index anisotropy on the surface and the back of the film, which is produced by adding, to a film formed of a cellulose acylate that has a high degree of substitution and is relatively easy to handle in its production, a material capable of controlling the wavelength dispersion characteristics of the in-plane retardation value Re of the film, followed by stretching the film. Further, in Comparative Examples therein, Patent Reference 1 describes an optical compensatory film having a small refractive index anisotropy on the surface and the back of the film, as a comparative case. In Patent Reference 1, however, only the ratio of the front contrast to the viewing angle contrast of the liquid-crystal display device produced by the use of the film obtained therein is investigated, but nothing is referred to therein relating to the front contrast value.

On the other hand, a cellulose acylate having a low degree of substitution has a high inherent birefringence, and is therefore considered to be able to realize high optical expressibility suitable to retardation films such as those for VA-mode devices, by reducing the degree of acyl substitution of the film. However, it is known that, when the cellulose acylate having a reduced degree of acyl substitution is formed into a film in a mode of solution casting film formation, then the peelability of the formed film from the support is poor, and as a result, the formed film is often difficult to peel, or even when the film could be peeled, there still occurs a problem in that the film may often have streaky unevenness in the direction perpendicular to the film traveling direction (machine direction) owing to the peeling failure from the support.

Regarding the problem in using such a cellulose acylate having a low degree of substitution, Patent Reference 2 proposes a method of improving the peelability of the formed film from the support, wherein a cellulose acylate having a degree of acyl substitution of from 2.0 to 2.7 is used as the core layer and a cellulose acylate having a degree of acyl substitution of at least 2.7 is used as the skin layer, and wherein the core layer and the skin layer, of which at least one contains a retardation-controlling agent, are so co-cast that the skin layer having a higher degree of acyl substation could be in contact with the support, and the resulting laminate film is stretched to thereby enhance the peelability thereof from the support while maintaining the high optical expressibility thereof. Patent Reference 2 discloses using a different retardation enhancer or reducer in the skin layer and the core layer and controlling the amount of the retardation enhancer or reducer in the skin layer and the core layer. However, the reference says that the techniques are all for attaining the in-plane uniformity of the optical characteristics of the formed film, but nothing is referred to therein relating to the refractive index difference between the surface and the back of the laminate film in changing the parameters and also relating to the front contrast of the liquid-crystal display device produced by the use of the formed film.
Patent Reference 1] JP-A 2010-26424
Patent Reference 2] JP-A 2010-58331

### SUMMARY OF THE INVENTION

Given the situation, the present inventors investigated the films described in Patent References 1 and 2, and have known that the front contrast of the liquid-crystal display device produced by the use of the film described in Examples and Comparative Examples in Patent Reference 1 is still unsatisfactory in point of the recent requirement in the art for further enhanced technical advantages. On the other hand, the laminate film composed of three layers of a skin layer, a core layer and a skin layer, as produced according to the production method described in Patent Reference 2, has a different refractive index anisotropy on the surface and the back thereof, and the present inventors have known that the front contrast of the liquid-crystal display device produced by the use of the laminate film is also unsatisfactory in point of the recent requirement in the art for further enhanced technical advantages.

The first object of the present invention is to provide a cellulose acylate laminate film which has high optical expressibility and good peelability from support and which, when incorporated in a liquid-crystal display device, realizes a high front contrast of the device. The second object of the invention is to provide a production method for the cellulose acylate laminate film, and a polarizer and a liquid-crystal display device using the cellulose acylate laminate film.

The present inventors have assiduously studied for the purpose of solving the above-mentioned problems, and as a result, have found that a cellulose acylate laminate film, which has a skin layer and a core layer each having a cellulose acylate with a specific total degree of acyl substitution and a retardation-controlling agent and in which the difference between the refractive index anisotropy measured on one surface and the refractive index anisotropy measured on the other surface is controlled to fall within a specific range, can solve the above-mentioned problems, and have completed the present invention described below.

[1] A cellulose acylate laminate film containing at least one skin B layer that contains a cellulose acetate satisfying the following formula (2) or (4) and a core layer that is thicker than the skin B layer and contains a cellulose acylate satisfying the following formula (1), wherein the core layer and the skin B layer contain a retardation-controlling agent having refractive index anisotropy and the difference between the refractive index anisotropy measured on one surface of the film and the refractive index anisotropy measured on the other surface thereof is at most 0.0005, provided that when at least one skin B layer contains a cellulose acetate satisfying the formula (4), the skin B layer contains a peeling promoter:

2.00<Z1≦2.50 (1)

wherein Z1 means a total degree of acyl substitution of the cellulose acylate in the core layer,

2.50≦Z2<3.00 (2)

2.00<Z2<2.50 (4)

wherein Z2 means a total degree of acyl substitution of the cellulose acylate in the skin B layer.
[2] A cellulose acylate laminate film containing at least one skin B layer that contains a cellulose acetate satisfying the following formula (2) and a core layer that is thicker than the skin B layer and contains a cellulose acylate satisfying the following formula (1), wherein the core layer and the skin B layer contain a retardation-controlling agent having refractive index anisotropy and the difference between the refractive index anisotropy measured on one surface of the film and the refractive index anisotropy measured on the other surface thereof is at most 0.0005:

2.00<Z1≦2.50 (1)

wherein Z1 means a total degree of acyl substitution of the cellulose acylate in the core layer,

2.50≦Z2<3.00 (2)

wherein Z2 means a total degree of acyl substitution of the cellulose acylate in the skin B layer.
[3] A cellulose acylate laminate film containing at least one skin B layer that contains a cellulose acetate satisfying the following formula (4) and a core layer that is thicker than the skin B layer and contains a cellulose acylate satisfying the following formula (3), wherein the core layer and the skin B layer contain a retardation-controlling agent having refractive index anisotropy, the skin B layer contains a peeling promoter, and the difference between the refractive index anisotropy measured on one surface of the film and the refractive index anisotropy measured on the other surface thereof is at most 0.0005:

2.00<Z1≦2.50 (3)

wherein Z1 means a total degree of acyl substitution of the cellulose acylate in the core layer,

2.00<Z2<2.50 (4)

wherein Z2 means a total degree of acyl substitution of the cellulose acylate in the skin B layer.
[4] The cellulose acylate laminate film according to any one of [1] to [3], wherein the skin B layer is only formed on one surface of the core layer, and a skin A layer that contains a cellulose acylate satisfying the following formula (5) is formed on the surface of the core layer opposite to the surface having the skin B layer:

2.50≦Z3<3.00 (5)

wherein Z3 means a total degree of acyl substitution of the cellulose acylate in the skin A layer.
[5] The cellulose acylate laminate film according to any one of [1] to [4], wherein the in-plane retardation Re of the cellulose acylate laminate film at a measuring wavelength of 590 nm satisfies 25 nm≦|Re|≦100 nm and the thickness-direction retardation Rth of the cellulose acylate laminate film satisfies 50 nm≦|Rth|≦250 nm.
[6] The cellulose acylate laminate film according to any one of [1] to [5], wherein the core layer has a mean thickness of from 30 to 100 μm.
[7] The cellulose acylate laminate film according to any one of [1] to [6], wherein the skin B layer has a mean thickness of from 0.2% to less than 25% of the mean thickness of the core layer.
[8] The cellulose acylate laminate film according to any one of [1] to [7], which has an internal haze of at most 0.08%.
[9] A method for producing a cellulose acylate laminate film, which comprises simultaneously or sequentially multi-casting a skin B layer dope that contains a cellulose acylate satisfying the following formula (2) or (4) and a core layer dope that contains a cellulose acylate satisfying the following formula (1) in that order on a support, drying the multi-cast dope to give a laminate film in which the core layer derived from the core layer dope is thicker than the skin B layer derived from the skin B layer dope, and peeling the laminate film from the support, and stretching the peeled laminate film, wherein a retardation-controlling agent having refractive index anisotropy is contained in the skin B layer dope and the core layer dope in such a controlled manner that the amount of the retardation-controlling agent to the skin B layer dope<the amount of the retardation-controlling agent to the core layer dope, provided that when the skin B layer dope contains a cellulose acylate satisfying the formula (4), the skin B layer dope also contains a peeling promoter:

2.00<Z1≦2.50 (1)

wherein Z1 means a total degree of acyl substitution of the cellulose acylate in the core layer,

2.50≦Z2<3.00 (2)

2.00≦Z2<2.50 (4)

wherein Z2 means a total degree of acyl substitution of the cellulose acylate in the skin B layer.
[10] A method for producing a cellulose acylate laminate film, which comprises a step of simultaneously or sequentially multi-casting a skin B layer dope that contains a cellulose acylate satisfying the following formula (2) and a core layer dope that contains a cellulose acylate satisfying the following formula (1) in that order on a support, a step of drying the multi-cast dope to give a laminate film in which the core layer derived from the core layer dope is thicker than the skin B layer derived from the skin B layer dope, and peeling the laminate film from the support, and a step of stretching the peeled laminate film, and which comprises a step of adding a retardation-controlling agent having refractive index anisotropy to the skin B layer dope and the core layer dope in such a controlled manner that the amount thereof to the skin B layer dope<the amount thereof to the core layer dope:

2.00<Z1≦2.50 (1)

wherein Z1 means a total degree of acyl substitution of the cellulose acylate in the core layer,

2.50≦Z2<3.00 (2)

wherein Z2 means a total degree of acyl substitution of the cellulose acylate in the skin B layer.
[11] A method for producing a cellulose acylate laminate film, which comprises a step of simultaneously or sequentially multi-casting a skin B layer dope that contains a cellulose acylate satisfying the following formula (4) and a core layer dope that contains a cellulose acylate satisfying the following formula (3) in that order on a support, a step of drying the multi-cast dope to give a laminate film in which the core layer derived from the core layer dope is thicker than the skin B layer derived from the skin B layer dope, and peeling the laminate film from the support, and a step of stretching the peeled laminate film, and which comprises a step of adding a retardation-controlling agent having refractive index anisotropy to the skin B layer dope and the core layer dope in such a controlled manner that the amount thereof to the skin B layer dope<the amount thereof to the core layer dope, with adding a peeling promoter to the skin B layer dope:

2.00<Z1≦2.50 (3)

wherein Z1 means a total degree of acyl substitution of the cellulose acylate in the core layer,

2.00≦Z2<2.50 (4)

wherein Z2 means a total degree of acyl substitution of the cellulose acylate in the skin B layer.
[12] The method for producing a cellulose acylate laminate film according to any one of [9] to [11], wherein a skin A layer dope that contains a cellulose acylate satisfying the following formula (5) is further multi-cast on the core layer dope, then the multi-cast dope is dried to give a laminate film in which the core layer derived from the core layer dope is thicker than the skin A layer derived from the skin A layer dope, and a retardation-controlling agent having refractive index anisotropy is contained in the skin B layer dope, the core layer dope and the skin A layer dope in such a controlled manner that the amount of the retardation-controlling agent to the skin B layer dope<the amount of the retardation-controlling agent to the core layer dope<the amount of the retardation-controlling agent to the skin A layer dope.

2.50≦Z3<3.00 (5)

wherein Z3 means a total degree of acyl substitution of the cellulose acylate in the skin A layer.
[13] The method for producing a cellulose acylate laminate film according to any one of [9] to [12], wherein the retardation-controlling agent is contained in the core layer dope in an mount of less than 40% by mass of the cellulose acylate in the dope.
[14] The method for producing a cellulose acylate laminate film according to any one of [9] to [13], wherein the retardation-controlling agent is contained in the skin B layer dope in an amount of less than 38% by mass of the cellulose acylate in the dope.
[15] The method for producing a cellulose acylate laminate film according to any one of [9] to [14], further comprising secondly stretching the film after the stretching of the peeled film.
[16] A cellulose acylate laminate film produced according to the cellulose acylate laminate film production method of any one of [9] to [15].
[17] A polarizer comprising at least one cellulose acylate laminate film of any one of [1] to [8] and [16].
[18] A liquid-crystal display device comprising at least one cellulose acylate laminate film of any one of [1] to [8] and [16] or comprising the polarizer of [17].

According to the invention, there is provided a cellulose acylate laminate film which has high optical expressibility and good peelability from support and which, when incorporated in a liquid-crystal display device, realizes a high front contrast of the device. The polarizer comprising the film is favorably used in liquid-crystal display devices, and is especially favorably bused in VA-mode liquid-crystal display devices.

### BRIEF DESCRIPTION OF THE DRAWINGS

FIG. 1 is a schematic view of one example of a casting die and therearound for use in the production method of the invention.

FIG. 2 is an explanatory view of one example of co-casting for use in the production method of the invention.

In the drawings, 70 is a cast film, 85 is a casting band, 120 is a core layer dope, 121 is a skin A layer dope, 122 is a skin B layer dope, 120a is a core layer, 121a is a skin A layer, 122a is a skin B layer, 150 is a skin B layer (support-facing layer) die, 151 is a core layer (substrate layer) die, 152 is a skin A layer (air-facing layer) die.

### DETAILED DESCRIPTION OF THE INVENTION

The invention is described in detail hereinunder.

The description of the constitutive elements of the invention given hereinunder is for some typical embodiments or specific examples of the invention, to which, however, the invention should not be limited. In this description, the numerical range expressed by the wording “a number to another number” means the range that falls between the former number indicating the lowermost limit of the range and the latter number indicating the uppermost limit thereof.

In this description, “retardation-controlling agent” is a compound that increases or decreases at least one of the in-plane direction retardation (hereinafter referred to as Re) of a film or a thickness-direction retardation (hereinafter referred to as Rth) of a film. “Retardation enhancer” is a compound that increases at least one of Re or Rth; and “retardation reducer” is a compound that decreases at least one of Re or Rth.

In this description, “core layer” is a layer having a largest thickness; and “skin layer” is a layer thinner than the core layer and kept in contact with the core layer.

In the description and the drawings, “skin layer” indicates both “skin A layer” and “skin B layer” in the preferred embodiments of the invention. The “skin A layer” may be referred to as “air-facing layer”; and the “skin B layer” may be referred to as “support-facing layer”. “Core layer” may be referred to as “substrate layer”.

### [Cellulose Acylate Laminate Film]

The first embodiment of the cellulose acylate laminate film of the invention (hereinafter this may be referred to as the film of the invention) contains at least one skin B layer that contains a cellulose acetate satisfying the following formula (2) and a core layer that is thicker than the skin B layer and contains a cellulose acylate satisfying the following formula (1), wherein the core layer and the skin B layer contain a retardation-controlling agent having refractive index anisotropy and the difference between the refractive index anisotropy measured on one surface of the film and the refractive index anisotropy measured on the other surface thereof is at most 0.0005:

2.00<Z1≦2.50 (1)

wherein Z1 means a total degree of acyl substitution of the cellulose acylate in the core layer,

2.50≦Z2<3.00 (2)

wherein Z2 means a total degree of acyl substitution of the cellulose acylate in the skin B layer.

The second embodiment of the cellulose acylate laminate film of the invention (hereinafter this may be referred to as the film of the invention) contains at least one skin B layer that contains a cellulose acetate satisfying the following formula (4) and a core layer that is thicker than the skin B layer and contains a cellulose acylate satisfying the following formula (3), wherein the core layer and the skin B layer contain a retardation-controlling agent having refractive index anisotropy, the skin B layer contains a peeling promoter, and the difference between the refractive index anisotropy measured on one surface of the film and the refractive index anisotropy measured on the other surface thereof is at most 0.0005:

2.00<Z1≦2.50 (3)

wherein Z1 means a total degree of acyl substitution of the cellulose acylate in the core layer,

2.00<Z2<2.50 (4)

wherein Z2 means a total degree of acyl substitution of the cellulose acylate in the skin B layer.

First, in both the first embodiment and the second embodiment of the film of the invention, a cellulose acylate having a low degree of substitution to satisfy the above-mentioned formula (1) or (3) is used as the core layer, thereby enhancing the optical characteristics expressibility of the entire cellulose acylate laminate film.

Next, in the first embodiment of the film of the invention, a film satisfying the above-mentioned formula (2) is used as the skin B layer, while in the second embodiment thereof, a peeling promoter is added to the skin B layer, thereby bettering the peelability of the cellulose acylate laminate film from support.

Further, both in the first embodiment and the second embodiment of the film of the invention, the amount of the retardation-controlling agent to be added to the core layer and the skin layer is so controlled that the amount could be smaller in the direction from the core layer to the skin B layer, according to the cellulose acylate production method of the invention to be mentioned hereinunder; and the laminate film is therefore characterized in that there exists no difference in the refractive index anisotropy between the surface and the back thereof, and consequently, when the laminate film is incorporated in a liquid-crystal display device, it realizes a high front contrast of the device.

Accordingly, having the configuration as above, the cellulose acylate laminate film of the invention has high optical characteristics expressibility and good peelability from support, as compared with conventional cellulose acylate films, and when incorporated in a liquid-crystal display device, the laminate film realizes a high front contrast of the device.

The characteristics and preferred embodiments of the cellulose acylate laminate film of the invention are described below.

### <Characteristics of Cellulose Acylate Laminate Film>

### (Refractive Index Anisotropy)

In this description, the refractive index anisotropy of the surface and the back of the film is a value measured according to the method mentioned below.

First, a sample film is left in an atmosphere at a temperature of 25° C. and a relative humidity of 60% for 24 hours. Next, using a prism coupler (Model 2010 Prism Coupler, by Metricon) and using a solid laser at 532 nm, the film sample is analyzed in the atmosphere at a temperature of 25° C. and a relative humidity of 60% for the refractive index thereof (n_{TE}) with a polarized light in the plane direction of the film and for the refractive index thereof (n_{TM}) with a polarized light in the normal direction to the plane direction of the film. The found data are substituted in the following formula (XII) to calculate the mean refractive index (n).

n=(n_{TE}×2+n_{TM})/3

wherein n_{TE} is the refractive index of the film measured with a polarized light in the plane direction of the film; and n_{TM} is the refractive index of the film measured with a polarized light in the normal direction to the plane direction of the film.

Next, using the above-mentioned laser in the atmosphere at a temperature of 25° C. and a relative humidity of 60%, the film sample is analyzed for the refractive index in the slow axis direction thereof (n_{TESA}) with a polarized light in the plane direction of the film and for the refractive index in the fast axis direction thereof (n_{TEFA}) with a polarized light in the plane direction of the film. The found data are substituted in the following formula (XIII) to calculate the refractive index anisotropy Δn around the surface and the back of the film.

Δn=n_{TESA}−n_{TEFA} (XIII)

wherein n_{TESA} is the refractive index in the slow axis direction of the film measured with a polarized light in the plane direction of the film; and n_{TEFA} is the refractive index in the fast axis direction of the film measured with a polarized light in the plane direction of the film.

The cellulose acylate laminate film of the invention is characterized in that the difference between the refractive index anisotropy measured on one surface of the film and the refractive index anisotropy measured on the other surface thereof is at most 0.0005. As a result of assiduous studies, the present inventors have found that, when the difference in the refractive index anisotropy between the surface and the back of a film is eliminated and when the film is incorporated in a liquid-crystal display device, then the front contrast of the device is increased. Heretofore, no one knows that the difference in the refractive index anisotropy between the surface and the back of a film would have some influence on the front contrast of a display device that comprises the film, and for example, nothing is investigated in both JP-A 2010-26424 and JP-A 2010-58331 relating to the correlativity between the difference in the refractive index anisotropy between the surface and the back of a film and the front contrast of a display device that comprises the film.

As a result of assiduous studies, the present inventors have found that, when the difference in the refractive index anisotropy between the surface and the back of a film is |Δn|≦0.00050 and when the film of the type is incorporated in a liquid-crystal display device, then the front contrast of the device is increased by about 10%, as compared with that of the display device comprising, as incorporated thereinto, a conventional film of which the difference in the refractive index anisotropy between the surface and the back is 0.00100. Preferably, the difference between the surface and the back of the film is |Δn|≦0.00025, more preferably |Δn|≦0.00010.

### (Internal Haze)

In this description, the internal haze is a haze value measured as follows: Using an oil of which the refractive index falls within a range of “refractive index ±0.02” of the thermoplastic resin contained most in the film, both surfaces of the film is coated with the oil to thereby exclude the surface-scattering component; and thus coated, the film is analyzed to determine the internal haze thereof. Concretely, the internal haze is measured as follows: A few drops of liquid paraffin are applied to the surface and the back of the film, and the film is sandwiched between two glass plates having a thickness of 1 mm (Microslide Glass Lot Number S9111, by Matsunami) so that the film is optically completely adhered to the two glass plates; and in this condition where the surface haze is removed, the haze of the sample is measured. Separately, liquid paraffin alone is sandwiched between two glass plates, and the haze thereof is measured. The latter value of the blank sample is subtracted from the front value of the film sample to determine the internal haze of the film.

Preferably, the internal haze of the cellulose acylate laminate film of the invention is at most 0.08. This is because when the film of the type is incorporated in a liquid-crystal display device as a polarizer protective film therein, then the front contrast of the device can be high. For preventing the contrast reduction, the internal haze is more preferably at most 0.07, even more preferably at most 0.06, still more preferably at most 0.05.

### (Layer Configuration of Film)

The cellulose acylate laminate film of the invention is a laminate of two or more layers including the above-mentioned core layer and skin B layer. Preferably, the film is a laminate of two layers or a laminate of three layers. In case where the cellulose acylate laminate film of the invention is a laminate of three layers, preferably, the film has the skin B layer only on one surface of the core layer and has a skin A layer on the surface thereof opposite to the surface having the above-mentioned skin layer B thereon. In the method for producing the cellulose acylate laminate film of the invention to be mentioned below, cellulose acylate solutions are simultaneously or sequentially multi-cast onto a support in the manner to be mentioned below; and also in the case, the layers could mix with each other at their boundary, not forming any definite interface therebetween.

The cellulose acylate to constitute each layer may be a cellulose acylate having the same degree of acyl substitution, or may be a cellulose acylate having a different degree of acyl substitution. In case where the cellulose acylate to constitute each layer has the same degree of acyl substitution, such is favorable from the viewpoint of the optical expressibility, the interlayer adhesiveness and the production cost of the laminate film.

In case where the second cellulose acylate film contains a cellulose acylate, one type alone of a cellulose acylate may be used for each layer, or multiple types of cellulose acylates may be mixed to be in one layer. Preferably, however, one type alone of a cellulose acylate is used for each layer from the viewpoint of controlling the optical characteristics of the laminate film.

### (Film Thickness)

The film of the invention contains the above-mentioned skin B layer and the core layer thicker than the skin B layer. In case where the film of the invention further contains the above-mentioned skin A layer, preferably, the core layer is thicker than the skin A layer. Having the configuration, the laminate film can more readily secure the optical characteristics expressibility that the cellulose acylate having a low degree of acyl substitution to satisfy the formula (1) or (3) possesses.

Preferably, the mean thickness of the core layer in the film of the invention is from 30 to 100 μm, more preferably from 30 to 80 μm, even more preferably from 30 to 70 μm. With the core layer having a thickness of at least 30 μm, the handleability of the web-like film in its production is favorably good. With the core layer having a thickness of at most 70 μm, the film can readily follow the ambient humidity change and can readily secure good optical characteristics.

In the film of the invention, preferably, the mean thickness of the skin B layer is from 0.2% to less than 25% of the mean thickness of the core layer. When it is at least 0.2%, then the peelability of the film may be enough, and the film may be free from troubles of streaky surface unevenness, thickness unevenness and uneven optical characteristics of the film; and when less than 25%, the core layer may effectively exhibit its optical expressibility. More preferably, it is from 0.5 to 15% from the viewpoint that the laminate film can have satisfactory optical characteristics, even more preferably from 1.0 to 10%. In case where the film of the invention further has the skin A layer, more preferably, both the mean thickness of the skin A layer and that of the skin B layer fall within a range of from 0.2% to less than 25% of the mean thickness of the core layer.

### (Re, Rth)

When the film of the invention is used as a retardation film or the like, its retardation, Re and Rth may be suitably determined depending on the design of the liquid-crystal cell and the optical film to which the film is applied. In general, preferably, Re is 25 nm≦|Re|≦100 nm, and the thickness-direction retardation Rth is 50 nm≦|Rth|≦250 nm. More preferably, 30 nm≦|Re|≦80 nm, even more preferably 35 nm≦|Re|≦70 nm. Also preferably, 70 nm≦|Rth|≦240 nm, more preferably 90 nm≦|Rth|≦230 nm.

In this description, Re(λ) and Rth(λ) each mean the in-plane retardation and the thickness-direction retardation, respectively, of a film at a wavelength of λ. Unless otherwise specifically indicated in this description, the wavelength λ is 590 nm. Re(λ) is measured by applying a light having a wavelength of λ nm to a film sample in the normal direction of the film, using KOBRA 21ADH (by Oji Scientific Instruments). With the in-plane slow axis (determined by KOBRA 21ADH) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH. Apart from this, Rth may also be measured as follows: With the slow axis taken as the tilt axis (rotation axis) of the film (in case where the film has no slow axis, the rotation axis of the film may be in any in-plane direction of the film), the retardation is measured in any desired two directions, and based on the thus-determined retardation data, the assumptive mean refractive index and the inputted film thickness, Rth is computed according to the following formulae (A) and (B). In this, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethyl methacrylate (1.49), polystyrene (1.59). With the assumptive mean refractive index and the film thickness inputted thereinto, KOBRA 21ADH can compute nx, ny and nz. From the thus-computed data nx, ny and nz, Nz=(nx−nz)/(nx−ny) is computed.

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( A )$$

In this, Re(θ) means the retardation of the film in the direction tilted by an angle θ from the normal direction to the film. d means the film thickness.

Rth={(nx+ny)/2−nz}×d (B)

The formula requires the mean refractive index n as the parameter therein, which may be determined with an Abbe's refractiometer (by Atago).

### <Cellulose Acylate>

Not specifically defined, the cellulose acylate for use in the invention may be any one in which the total degree of substitution with acyl group satisfies the above-mentioned formulae (1) and (2) in the first embodiment of the invention, or satisfies the above-mentioned formulae (3) and (4) in the second embodiment of the invention. The starting cellulose for the cellulose acylate includes cotton linter and wood pulp (hardwood pulp, softwood pulp), etc.; and any cellulose acylate obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8; and cellulose materials described in these may be used here.

First, the cellulose acylate preferably used in the present invention is described in detail. The β-1,4-bonding glucose unit to constitute cellulose has a free hydroxyl group at the 2-, 3- and 6-positions. The cellulose acylate is a polymer produced by esterifying apart or all of those hydroxyl groups in cellulose with an acyl group. The degree of acyl substitution means the total of the ratio of esterification of the hydroxyl group in cellulose positioned in the 2-, 3- and 6-positions in the unit therein. In case where the hydroxyl group is 100% esterified at each position, the degree of substitution at that position is 1.

The preferred range of the cellulose acylate for use in the first embodiment of the invention is described.

The cellulose acylate laminate film of the first embodiment of the invention contains at least one skin B layer that contains a cellulose acetate satisfying the following formula (2) and a core layer that is thicker than the skin B layer and contains a cellulose acylate satisfying the following formula (1):

2.00<Z1≦2.50 (1)

wherein Z1 means a total degree of acyl substitution of the cellulose acylate in the core layer,

2.50≦Z2<3.00 (2)

wherein Z2 means a total degree of acyl substitution of the cellulose acylate in the skin B layer.

In the formula (1), Z1 preferably satisfies 2.1<Z1<2.5, more preferably 2.3<Z1<2.5.

In the formula (2), Z2 preferably satisfies 2.75<Z2<2.95, more preferably 2.80<Z2<2.90.

The cellulose acylate laminate film of the second embodiment of the invention contains at least one skin B layer that contains a cellulose acetate satisfying the following formula (4) and a core layer that is thicker than the skin B layer and contains a cellulose acylate satisfying the following formula (3):

2.00<Z1≦2.50 (3)

wherein Z1 means a total degree of acyl substitution of the cellulose acylate in the core layer,

2.00<Z2<2.50 (4)

wherein Z2 means a total degree of acyl substitution of the cellulose acylate in the skin B layer.

In the formula (3), Z1 preferably satisfies 2.1<Z1≦2.5, more preferably 2.3<Z1≦2.5.

In the formula (4), Z4 preferably satisfies 2.1<Z1≦2.5, more preferably 2.3<Z1≦2.5.

In the film of the invention, more preferably, the cellulose acylate for use for the core layer satisfies the following formulae (11) and (12) from the viewpoint of enhancing the optical expressibility of the film.

1.0<X1<2.7 (11)

wherein X1 means a degree of substitution with an acetyl group of the cellulose acylate in the core layer,

0≦Y1<1.5 (12)

wherein Y1 means a total degree of substitution with an acyl group having 3 or more carbon atoms of the cellulose acylate in the core layer.

X1 preferably satisfies 1.5<X1<2.7, more preferably 2.0<X1<2.7.

Y1 preferably satisfies 0≦Y1<1.3, more preferably 0≦Y1<1.0.

Further preferably, in the film of the invention, the cellulose acylate for use for the skin A layer and the skin B layer satisfies the following formulae (13) and (14) from the viewpoint of enhancing the peelability of the film from support in addition to enhancing the optical expressibility of the film.

1.2<X2<3.0 (13)

wherein X2 means a degree of substitution with an acetyl group of the cellulose acylate in the skin layer,

0≦Y2<1.5 (14)

wherein Y2 means a total degree of substitution with an acyl group having 3 or more carbon atoms of the cellulose acylate in the skin layer.

X2 preferably satisfies 1.5<X2<2.0, more preferably 1.8<X2<3.0.

Y2 preferably satisfies 0≦Y2<1.3, more preferably 0≦Y2<1.0.

More preferably, the film of the invention has the skin B layer only on one surface of the core layer and has a skin A layer that contains a cellulose acylate satisfying the following formula (5), on the surface thereof opposite to the surface having the skin B layer thereon, from the viewpoint of favorably controlling the physical properties of the film (especially for preventing the film from curling).

2.50≦Z3<3.00 (5)

wherein Z3 means a total degree of acyl substitution of the cellulose acylate in the skin A layer.

The preferred range of Z3 in the formula (5) is the same as the preferred range of Z2 in the above-mentioned formula (2).

The acyl group having 2 or more carbon atoms in the cellulose acylate in the invention may be an aliphatic group or an aryl group, and is not specifically defined. For example, the ester includes alkylcarbonyl esters, alkenylcarbonyl esters, aromatic carbonyl ester, aromatic alkylcarbonyl esters and the like of cellulose, and may additionally have a substituent. Preferred examples of the group include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group, a cinnamoyl group, etc. Of those, more preferred are an acetyl group, a propionyl group, a butanoyl group, a dodecanoyl group, an octadecanoyl group, a tert-butanoyl group, an oleoyl group, a benzoyl group, a naphthylcarbonyl group, a cinnamoyl group, etc.; even more preferred are an acetyl group, a propionyl group, a butanoyl group (as a case where the acyl group has from 2 to 4 carbon atoms); and still more preferred is an acetyl group (as a case the cellulose acylate is cellulose acetate).

In acylation of cellulose, when an acid anhydride or an acid chloride is used as the acylating agent, an organic acid, for example, acetic acid, methylene chloride or the like is used as the organic solvent for the reaction solvent.

When the acylating agent is an acid anhydride, the catalyst is preferably a protic catalyst; but when the acylating agent is an acid chloride (for example, CH₃CH₂COCl), preferably used is a basic compound.

A most popular industrial production method for a mixed fatty acid ester of cellulose is a method of acylating cellulose with a mixed organic acid component that comprises fatty acids corresponding to an acetyl group and to any other acyl group (acetic acid, propionic acid, valeric acid, etc.) or their acid anhydrides.

The cellulose acylate for use in the invention may be produced, for example, according to the method described in JP-A 10-45804.

### <Retardation-Controlling Agent>

The film of the invention contains a retardation-controlling agent having refractive index anisotropy in the core layer and the skin B layer therein. In case where the film of the invention further has the above-mentioned skin A layer, preferably, the skin layer A also contains such a retardation-controlling agent having refractive index anisotropy.

In the cellulose acylate laminate film of the invention, preferably, the amount of the retardation-controlling agent added to the core layer is at most 35% by mass of the cellulose acylate and the amount of the retardation-controlling agent added to the skin B layer is at most 35% by mass of the cellulose acylate, from the viewpoint that the internal haze of the obtained film can be reduced. In the preferred embodiment of the cellulose acylate laminate film of the invention that has a skin A layer, also preferably, the amount of the retardation-controlling agent added to the skin A layer is at most 35% by mass of the cellulose acylate.

As the retardation-controlling agent, herein usable are polycondensation polymers, sugar ester compounds, other retardation enhancers, other retardation reducers, etc. In the invention, preferably, at least one of polycondensation polymers and sugar ester compounds is used as the retardation-controlling agent.

### (Polycondensation Polymer)

Preferably, the cellulose acylate laminate film contains a polycondensation polymer (hereinafter this may also be referred to as polycondensation ester compound) from the viewpoint of reducing the internal haze of the film.

As the polycondensation polymer, herein widely usable are high-molecular-weight additives known as additives to cellulose acylate films. The additive content is preferably from 1 to 35% by mass of the cellulose acylate, more preferably from 4 to 30% by mass, even more preferably from 10 to 25% by mass.

The high-molecular-weight additive to be used as the polycondensation polymer in the cellulose acylate laminate film is a compound having a recurring unit in the molecule thereof, and preferably has a number-average molecular weight of from 600 to 10000. The high-molecular-weight additive additionally has a function of accelerating the evaporation speed of solvent as well as a function of reducing the residual solvent amount in the solution casting method for the film. Further, from the viewpoint of enhancing the mechanical properties of the film, for imparting flexibility and water absorption resistance to the film, and for reducing the moisture permeability of the film, the additive exhibits useful effects. In addition, the polycondensation polymer is further effective from the viewpoint of promoting the miscibility of the above-mentioned organic acid with cellulose acylate to thereby prevent the film from whitening.

More preferably, the number-average molecular weight of the high-molecular-weight additive of the polycondensation polymer for use in the invention is from 600 to 8000, even more preferably from 600 to 5000, still more preferably from 700 to 2000.

The high-molecular-weight additive of the polycondensation polymer for use in the invention is described in detail with reference to its specific examples given hereinunder; however, needless-to-say, the high-molecular-weight additive of the polycondensation polymer for use in the invention is not limited to these examples.

Preferably, the polycondensation polymer is a non-phosphate-type ester compound. The “non-phosphate-type ester compound” means an ester compound not including phosphate esters.

As the high-molecular-weight additive of the polycondensation polymer, there are mentioned polyester polymers (aliphatic polyester polymers, aromatic polyester polymers, etc.), copolymers of a polyester component and any other component, etc. Preferred here are aliphatic polyester polymers, aromatic polyester polymers, copolymers of a polyester polymer (aliphatic polyester polymer, aromatic polyester polymer, etc.) and an acrylic polymer, and copolymers of a polyester polymer (aliphatic polyester polymer, aromatic polyester polymer, etc.) and a styrenic polymer; and more preferred are polyester compounds having an aromatic ring as at least one copolymerization component.

The aliphatic polyester polymer is preferably one prepared through reaction of an aliphatic dicarboxylic acid having from 2 to 20 carbon atoms, and at least one diol selected from aliphatic diols having from 2 to 12 carbon atoms and an alkyl ether diols having from 4 to 20 carbon atoms. Both ends of the reaction product may be as they are in the reaction product, but may be further reacted with a monocarboxylic acid, a monoalcohol or a phenol for endcapping. The endcapping is attained in order that the product does not contain any free carboxylic acid, and is effective for preservability of the polymer. The dicarboxylic acid for use for the polyester polymer is preferably an aliphatic dicarboxylic acid having from 4 to 20 carbon atoms, or an aromatic dicarboxylic acid having from 8 to 20 carbon atoms.

The dicarboxylic acid having from 2 to 20, which is preferred for use in the invention, includes, for example, oxalic acid, malonic acid, succinic acid, maleic acid, fumaric acid, glutaric acid, adipic acid, pimelic acid, suberic acid, azelaic acid, sebacic acid, dodecanedicarboxylic acid, and 1,4-cyclohexanedicarboxylic acid.

Of those, preferred aliphatic dicarboxylic acids are malonic acid, succinic acid, maleic acid, fumaric acid, glutaric acid, adipic acid, azelaic acid, 1,4-cyclohexanedicarboxylic acid. More preferred aliphatic dicarboxylic acids are succinic acid, glutaric acid, adipic acid.

The diol for use for the high-molecular-weight additive is, for example, selected from aliphatic diols having from 2 to 20 carbon atoms, and alkylether diols having from 4 to 20 carbon atoms.

The aliphatic diol having from 2 to 20 carbon atoms includes alkyldiols and alicyclic diols. For example, there are mentioned ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, etc. One alone or two or more different types of these glycols may be used here either singly or as combined as a mixture thereof.

Preferred aliphatic diols for the invention are ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, 1,4-cyclohexanedimethanol; and more preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol, 1,4-cyclohexanedimethanol.

The alkyl ether diol having from 4 to 20 carbon atoms is preferably polytetramethylene ether glycol, polyethylene ether glycol, polypropylene ether glycol and their combination. Not specifically defined, the mean degree of polymerization of the diol is preferably from 2 to 20, more preferably from 2 to 10, even more preferably from 2 to 5, still more preferably from 2 to 4. As examples of the diol, there are mentioned typically useful, commercially-available polyether glycols, Carbowax Resin, Pluronics Resin and Niax Resin.

Preferable is a polycondensation polymer terminal-capped with an alkyl group or an aromatic group. This is because terminal capping with a hydrophobic functional group is effective for enhancing the aging resistance of the compound in high-temperature high-humidity environments, and the terminal capping group could act to retard the hydrolysis of the ester group.

Preferably, both terminals of the polycondensation polymer as a polyester additive are protected with a monoalcohol residue or a monocarboxylic acid residue so as not to be a carboxylic acid group or an OH group.

In this case, the monoalcohol is preferably a substituted or unsubstituted monoalcohol having from 1 to 30 carbon atoms, including aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol, etc.; and substituted alcohols such as benzyl alcohol, 3-phenylpropanol, etc.

Terminal capping alcohols preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol; and more preferred are methanol, ethanol, propanol, isobutanol, cyclohexyl alcohol, 2-ethylhexyl alcohol, isononyl alcohol, benzyl alcohol.

In case where the additive is terminal-capped with a monocarboxylic acid residue, the monocarboxylic acid for the monocarboxylic acid residue is preferably a substituted or unsubstituted monocarboxylic acid having from 1 to 30 carbon atoms. The monocarboxylic acid may be an aliphatic monocarboxylic acid or an aromatic ring-containing monocarboxylic acid. As preferred aliphatic monocarboxylic acids for use herein, there are mentioned acetic acid, propionic acid, butanoic acid, caprylic acid, caproic acid, decanoic acid, dodecanoic acid, stearic acid, oleic acid; and preferred aromatic ring-containing monocarboxylic acids are, for example, benzoic acid, p-tert-butylbenzoic acid, p-tert-amylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid, etc. One or more of these may be used here.

The polycondensation polymer as mentioned above for the invention can be produced according to an ordinary method. For example, the additive can be produced with ease according to a thermal melt condensation method of polyesterification or interesterification of the above-mentioned dicarboxylic acid and diol and/or the terminal capping monocarboxylic acid or monoalcohol; or according to an interfacial condensation method of an acid chloride of those acids and a glycol. The polyester additives are described in detail by Koichi Murai in “Additives, Theory and Application” (published by Miyuki Shobo Publishing, Mar. 1, 1973, 1st Printing of 1st Version). In addition, the materials described in JP-A 05-155809, JP-A 05-155810, JP-A 5-197073, JP-A 2006-259494, JP-A 07-330670, JP-A 2006-342227, and JP-A 2007-003679 are also usable here.

Preferably, the polycondensation polymer is added to each layer in a ratio of from 0.01 to 30% by mass to the cellulose acylate in the layer, more preferably in a ratio of from 0.1 to 20% by mass, even more preferably in a ratio of from 5 to 20% by mass.

Sugar Residue

The sugar ester compound means a compound where at least one substitutable group (for example, hydroxyl group, carboxyl group) in the polyose constituting the compound is ester-bonded to at least one substituent therein. Specifically, the sugar ester compound as referred to herein includes sugar derivatives in a broad sense of the word, and for example, includes compounds having a sugar residue as the structural unit thereof such as gluconic acid. Concretely, the sugar ester compound includes an ester of glucose and a carboxylic acid, and an ester of gluconic acid and an alcohol.

The substitutable group in the polyose constituting the sugar ester compound is preferably a hydroxyl group.

The sugar ester compound includes a polyose-derived structure (hereinafter this may be referred to as a sugar residue) that constitutes the sugar ester compound. The structure per monose of the sugar residue is referred to as the structural unit of the sugar ester compound. The structural unit of the sugar ester compound preferably includes a pyranose structural unit or a furanose structural unit, more preferably, all the sugar residues are pyranose structural units or furanose structural units. In case where the sugar ester is formed of a polyose, it preferably includes both a pyranose structural unit and a furanose structural unit.

The sugar residue of the sugar ester compound may be a pentose-derived one or a hexose-derived one, but is preferably a hexose-derived one.

Preferably, the number of the structural units contained in the sugar ester compound is from 2 to 4, more preferably 2 or 3, even more preferably 2. The sugar composing the sugar ester compound is preferably a di- to tetra-saccharide, more preferably disaccharide or trisaccharide, even more preferably disaccharide.

In the invention, preferably, the sugar ester compound contains from 2 to 4 pyranose structural units or furanose structural units in which at least one hydroxyl group is esterified, even more preferably, two pyranose structural units or furanose structural units in which at least one hydroxyl group is esterified.

Examples of monoses or polyoses containing from 2 to 4 monose units include, for example, erythrose, threose, ribose, arabinose, xylose, lyxose, arose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, baltopentaose, belbascose, maltohexaose, xylitol, sorbitol, etc.

Preferred are ribose, arabinose, xylose, lyxose, glucose, fructose, mannose, galactose, trehalose, maltose, cellobiose, lactose, sucrose, sucralose, xylitol, sorbitol; more preferred are arabinose, xylose, glucose, fructose, mannose, galactose, maltose, cellobiose, sucrose; and even more preferred are xylose, glucose, fructose, mannose, galactose, maltose, cellobiose, sucrose, xylitol, sorbitol.

Preferred examples of the substituent for the sugar ester compounds include an alkyl group (preferably an alkyl group having from 1 to 22 carbon atoms, more preferably from 1 to 12 carbon atoms, even more preferably from 1 to 8 carbon atoms, for example, a methyl group, an ethyl group, a propyl group, a hydroxyethyl group, a hydroxypropyl group, a 2-cyanoethyl group, a benzyl group, etc.), an aryl group (preferably an aryl group having from 6 to 24 carbon atoms, more preferably from 6 to 18 carbon atoms, even more preferably from 6 to 12 carbon atoms, for example, a phenyl group, a naphthyl group), an acyl group (preferably an acyl group having from 1 to 22 carbon atoms, more preferably from 2 to 12 carbon atoms, even more preferably from 2 to 8 carbon atoms, for example, an acetyl group, a propionyl group, a butyryl group, a pentanoyl group, a hexanoyl group, an octanoyl group, a benzoyl group, a toluoyl group, a phthalyl group, etc.), an amide group (preferably an amide group having from 1 to 22 carbon atoms, more preferably from 2 to 12 carbon atoms, even more preferably from 2 to 8 carbon atoms, for example, a formamide group, an acetamide group, etc.), an imide group (preferably an imide group having from 4 to 22 carbon atom, more preferably from 4 to 12 carbon atoms, even more preferably from 4 to 8 carbon atoms, for example, a succinimide group, a phthalimide group, etc.). Of those, preferred are an alkyl group and an acyl group; and more preferred are a methyl group, an acetyl group, a propionyl group, a butyryl group (especially an i-butyryl group), and a benzoyl group. More preferably, the compound contains at least one of an acetyl group and a butyryl group; and even more preferably, the compound contains an acetyl group alone, or both an acetyl group and a butyryl group.

As other sugar ester compounds, also usable here are the sugar ester compounds described in JP-A 2001-247717, JP-T 2005-515285, WO2007/125764, WO2009/011228, WO2009/031464.

The sugar ester compounds are available as commercial products from Tokyo Chemical, Aldrich, etc., or may be produced by processing commercial hydrocarbons according to known esterification methods (for example, as in JP-A 8-245678).

Preferably, the sugar ester compounds have a number-average molecular weight of from 200 to 3500, more preferably from 420 to 3000, even more preferably from 450 to 2000.

Preferably, the sugar ester compound is added to the film in an amount of from 2 to 35% by mass of the cellulose acylate, more preferably from 5 to 20% by mass, even more preferably from 10 to 15% by mass.

### (Other Retardation Enhancer)

The film of the invention may contain a retardation enhancer for expressing retardation. Not specifically defined, the retardation enhancer includes rod-shaped or discotic compounds, and compounds having a structure represented by the general formula (II-1) to be mentioned below. As the rod-shaped or discotic compounds, preferred for the retardation enhancer for use herein are compounds having at least two aromatic rings.

The amount of the retardation enhancer of a rod-shaped compound to be added is preferably from 0.1 parts by mass to less than 3 parts by mass relative to 100 parts by mass of the cellulose acylate component, more preferably from 0.5 parts by mass to less than 2 parts by mass. On the other hand, the amount of the discotic compound is preferably from 0.1 to 10% by mass of the cellulose acylate, more preferably from 0.5 to 4% by mass, even more preferably from 1 to 3% by mass. The preferred amount to be added of the compound having a structure represented by the general formula (II-1) to be mentioned below falls within the same range as that of the discotic compound mentioned above, relative to the cellulose acylate.

Discotic compounds and compounds having a structure represented by the general formula (II-1) to be mentioned below are superior to rod-shaped compounds in point of the Rth retardation expressibility, and therefore, in a case where an especially high-level Rth retardation is needed, the former compounds are preferably used. Two or more different types of retardation enhancers may be combined for use herein.

Preferably, the retardation enhancer has a maximum absorption in a wavelength region of from 250 to 400 nm but does not substantially have any absorption in a visible light range.

Discotic compounds are described. Discotic compounds having at least two aromatic rings are usable here.

In this description, “aromatic ring” includes not only an aromatic hydrocarbon ring but also an aromatic hetero ring.

The aromatic hydrocarbon ring is especially preferably a 6-membered ring (or that is, benzene ring).

The aromatic hetero ring is generally an unsaturated hetero ring. The aromatic hetero ring is preferably a 5-membered ring, a 6-membered ring or a 7-membered ring, and more preferably a 5-membered ring or a 6-membered ring. The aromatic hetero ring generally has a largest number of double bonds. As the hetero atom, preferred are a nitrogen atom, an oxygen atom and a sulfur atom, and more preferred is a nitrogen atom. Examples of the aromatic hetero ring include a furan ring, a thiophene ring, a pyrrole ring, an oxazole ring, an isoxazole ring, a triazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic ring, preferred are a benzene ring, a condensed benzene ring and biphenyls. Especially preferred is a 1,3,5-triazine ring. Concretely, for example, use of the compounds disclosed in JP-A 2001-166144 is preferred here.

Preferably, the carbon number of the aromatic ring that the retardation enhancer has is from 2 to 20, more preferably from 2 to 12, even more preferably from 2 to 8, most preferably from 2 to 6.

The bonding mode of two aromatic rings in the retardation enhancer includes (a) a case of forming a condensed ring, (b) a case of direct bonding via a single bond, and (c) a case of bonding via a linking group (aromatic rings could not form a spiro bond). Any of those bonding modes (a) to (c) is employable here.

Examples of condensed ring of the case (a) (condensed rings of two or more aromatic rings) include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolidine rind, a benzoxazole ring, a benzothiazole ring, a benzimidazole ring, a benzotriazole ring, a purine ring, a indazole ring, a chromene ring, a quinoline ring, an isoquinoline ring, a quinolidine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathine ring, phenoxazine ring and a thianthrene ring. Preferred are a naphthalene ring, an azulene ring, an indole ring, a benzoxazole ring, a benzothiazole ring, a benzimidazole ring, a benzotriazole ring and a quinoline ring.

The single bond in (b) is preferably a bond between the carbon atoms of two aromatic rings. Two aromatic rings may be bonded via 2 or more single bonds, thereby forming an aliphatic ring or a non-aromatic hetero ring between the two aromatic rings.

Also preferably, the linking group in (c) is to link the carbon atoms of two aromatic rings. The linking group is preferably an alkylene group, an alkenylene group, an alkynylene group, —CO—, —O—, —NH—, —S— or a combination thereof. Examples of the linking group comprising a combination of the above groups are shown below. Regarding the relationship therebetween, the right side and the left side groups in the examples of linking groups mentioned below may be reversed to each other.

c1: —CO—O—

c2: —CO—NH—

c3: -alkylene-O—

c4: —NH—CO—NH—

c5: —NH—CO—O—

c6: —O—CO—O—

c7: —O-alkylene-O—

c8: —CO-alkenylene-

c9: —CO-alkenylene-NH—

c10: —CO-alkenylene-O—

c11: -alkylene-CO—O-alkylene-O—CO-alkylene-

c12: —O-alkylene-CO—O-alkylene-O—CO-alkylene-O—

c13: —O—CO-alkylene-CO—O—

c14: —NH—CO-alkenylene-

c15: —O—CO-alkenylene-

The aromatic ring and the linking group may have a substituent.

Examples of the substituent include a halogen atom (F, Cl, Br, I), a hydroxyl group, a carboxyl group, a cyano group, an amino group, a nitro group, a sulfo group, a carbamoyl group, a sulfamoyl group, an ureido group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfonamide group, an aliphatic substituted amino group, an aliphatic substituted carbamoyl group, an aliphatic substituted sulfamoyl group, an aliphatic substituted ureido group and a non-aromatic heterocyclic group.

Preferably, the carbon number of the alkyl group is from 1 to 8. As the alkyl group, preferred is a chain-like alkyl group rather than a cyclic alkyl group, and more preferred is a linear alkyl group. The alkyl group may be further substituted (for example, with a hydroxy group, a carboxyl group, an alkoxy group, or an alkyl-substituted amino group). Examples of the alkyl group (including substituted alkyl group) include a methyl group, an ethyl group, an n-butyl group, an n-hexyl group, a 2-hydroxyethyl group, a 4-carboxybutyl group, a 2-methoxyethyl group and a 2-diethylaminoethyl group.

Preferably, the carbon number of the alkenyl group is from 2 to 8. As the alkenyl group, preferred is a chain-like alkenyl group rather than a cyclic alkenyl group, and more preferred is a linear alkenyl group. The alkenyl group may be further substituted. Examples of the alkenyl group include a vinyl group, an allyl group and a 1-hexenyl group.

Preferably, the carbon number of the alkynyl group is from 2 to 8. As the alkynyl group, preferred is a chain-like alkynyl group rather than a cyclic alkynyl group, and more preferred is a linear alkynyl group. The alkynyl group may be further substituted. Examples of the alkynyl group include an ethynyl group, a 1-butynyl group and a 1-hexynyl group.

Preferably, the carbon number of the aliphatic acyl group is from 1 to 10. Examples of the aliphatic acyl group include an acetyl group, a propanoyl group and a butanoyl group.

Preferably, the carbon number of the aliphatic acyloxy group is from 1 to 10. Examples of the aliphatic acyloxy group include an acetoxy group.

Preferably, the carbon number of the alkoxy group is from 1 to 8. The alkoxy group may be further substituted (for example, with an alkoxy group). Examples of the alkoxy group (including substituted alkoxy group) include a methoxy group, an ethoxy group, a butoxy group and a methoxyethoxy group.

Preferably, the carbon number of the alkoxycarbonyl group is from 2 to 10. Examples of the alkoxycarbonyl group include a methoxycarbonyl group and an ethoxycarbonyl group.

Preferably, the carbon number of the alkoxycarbonylamino group is from 2 to 10. Examples of the alkoxycarbonylamino group include a methoxycarbonylamino group and an ethoxycarbonylamino group.

Preferably, the carbon number of the alkylthio group is from 1 to 12. Examples of the alkylthio group include a methylthio group, an ethylthio group and an octylthio group.

Preferably, the carbon number of the alkylsulfonyl group is from 1 to 8. Examples of the alkylsulfonyl group include a methanesulfonyl group and an ethanesulfonyl group.

Preferably, the carbon number of the aliphatic amide group is from 1 to 10. Examples of the aliphatic amide group include an acetamide group.

Preferably, the carbon number of the aliphatic sulfonamide group is from 1 to 8. Examples of the aliphatic sulfonamide group include a methanesulfonamide group, a butanesulfonamide group and an n-octanesulfonamide group.

Preferably, the carbon number of the aliphatic substituted amino group is from 1 to 10. Examples of the aliphatic substituted amino group include a dimethylamino group, a diethylamino group and a 2-carboxyethylamino group.

Preferably, the carbon number of the aliphatic substituted carbamoyl group is from 2 to 10. Examples of the aliphatic substituted carbamoyl group include a methylcarbamoyl group and a diethylcarbamoyl group.

Preferably, the carbon number of the aliphatic substituted sulfamoyl group is from 1 to 8. Examples of the aliphatic substituted sulfamoyl group include a methylsulfamoyl group and a diethylsulfamoyl group.

Preferably, the carbon number of the aliphatic substituted ureido group is from 2 to 10. Examples of the aliphatic substituted ureido group include a methylureido group.

Examples of the non-aromatic heterocyclic group include a piperidino group and a morpholino group.

Preferably, the molecular weight of the retardation enhancer is from 300 to 800.

In the invention, as the discotic compound, preferred is use of triazine compounds represented by the following general formula (I):

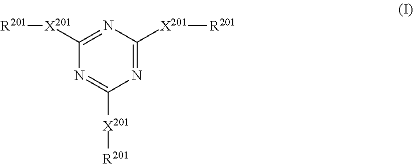

In the above formula (I),

R²⁰¹ each independently represents an aromatic ring or a hetero ring having a substituent at any of ortho-, meta- and para-positions.

X²⁰¹ each independently represents a single bond or —NR²⁰²—. In this, R²⁰² each independently represent a hydrogen atom, or a substituted or unsubstituted alkyl, alkenyl, aryl or heterocyclic group.

Preferably, the aromatic ring represented by R²⁰¹ is phenyl or naphthyl, more preferably phenyl. The aromatic ring represented by R²⁰¹ is may have at least one substituent at any substitution position thereof. Examples of the substituent include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamide group, a carbamoyl group, an alkyl-substituted carbamoyl group, an alkenyl-substituted carbamoyl group, an aryl-substituted carbamoyl group, an amide group, an alkylthio group, an alkenylthio group, an arylthio group and an acyl group.

The heterocyclic group represented by R²⁰¹ is preferably aromatic. The aromatic hetero ring is generally an unsaturated hetero ring and is preferably a hetero ring having a largest number of double bonds. Preferably, the hetero ring is a 5-membered ring, a 6-membered ring or a 7-membered ring, more preferably a 5-membered ring or a 6-membered ring, most preferably a 6-membered ring. Preferably, the hetero atom of the hetero ring is a nitrogen atom, a sulfur atom or an oxygen atom, more preferably a nitrogen atom. As the aromatic hetero ring, especially preferred is a pyridine ring (as the heterocyclic group thereof, 2-pyridyl or 4-pyridyl). The heterocyclic group may have a substituent. Examples of the substituent of the heterocyclic group are the same as those of the substituent of the above-mentioned aryl moiety.

The heterocyclic group in a case where X²⁰¹ is a single bond is preferably a heterocyclic group having a free atomic valence at the nitrogen atom thereof. The heterocyclic group having a free atomic valence at the nitrogen atom thereof is preferably a 5-membered ring, a 6-membered ring or a 7-membered ring, more preferably a 5-membered ring or a 6-membered ring, most preferably a 5-membered ring. The heterocyclic group may have multiple nitrogen atoms. The heterocyclic group may have any other hetero atom (e.g., O, S) than the nitrogen atom. Examples of the heterocyclic group having a free atomic valence at the nitrogen atom thereof are mentioned below. In these, —C₄H₉ⁿ means n-C₄H₉.

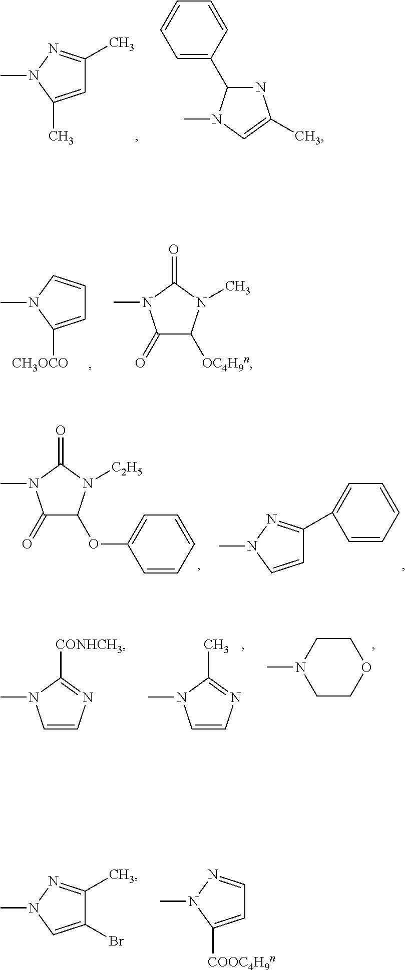

The alkyl group represented by R²⁰² may be a cyclic alkyl group or a chain-like alkyl group, but is preferably a chain-like alkyl group, more preferably a linear alkyl group rather than a branched chain-like alkyl group. The carbon number of the alkyl group is preferably from 1 to 30, more preferably from 1 to 20, even more preferably from 1 to 10, still more preferably from 1 to 8, most preferably from 1 to 6. The alkyl group may have a substituent. Examples of the substituent include a halogen atom, an alkoxy group (for example, methoxy group, ethoxy group) and an acyloxy group (for example, acryloyloxy group, methacryloyloxy group).

The alkenyl group represented by R²⁰² may be a cyclic alkenyl group or a chain-like alkenyl group, but is preferably a chain-like alkenyl group, more preferably a linear alkenyl group rather than a branched chain-like alkenyl group. The carbon number of the alkenyl group is preferably from 2 to 30, more preferably from 2 to 20, even more preferably from 2 to 10, still more preferably from 2 to 8, most preferably from 2 to 6. The alkenyl group may have a substituent. Examples of the substituent are the same as those of the substituent of the alkyl group mentioned above.

The aromatic cyclic group and the heterocyclic group represented by R²⁰² are the same as the aromatic ring and the hetero ring represented by R²⁰¹, and preferred examples of the former are also the same as those of the latter. The aromatic cyclic group and the heterocyclic group may be further substituted, and examples of the substituent for these are the same as those of the substituent for the aromatic cyclic group and the heterocyclic group of R²⁰¹.

The compounds represented by the general formula (I) may be produced in any known methods, for example, according to the method described in JP-A 2003-344655, etc. The details of the retardation enhancer are described in Disclosure Bulletin No. 2001-1745, p. 49.

Also preferably, a compound having a structure represented by the following general formula (II-1) is used here as the discotic compound. However, the compound characterized by the structure represented by the following general formula (II-1) is not needed to be discotic.

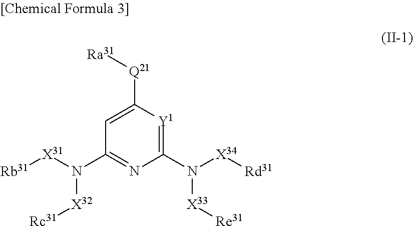

In the formula (II-1), Y¹ represents a methine group or —N—. Ra³¹ represents an alkyl group, an alkenyl group, an alkynyl group, an aryl group or a heterocyclic group. Rb³¹, Rc³¹, Rd³¹ and Re³¹ each independently represent a hydrogen atom, an alkyl group, an alkenyl group, an alkynyl group, an aryl group or a heterocyclic group. Q²¹ represents a single bond, —O—, —S—, or —NRf—; Rf represents a hydrogen atom, an alkyl group, an alkenyl group, an alkynyl group, an aryl group or a heterocyclic group, and may bond to Ra³¹ to form a ring. X³¹, X³² and X³³ each independently represent a single bond or a divalent linking group. X³⁴ represents a linking group selected from a group consisting of divalent linking groups represented by the following general formula (Q):

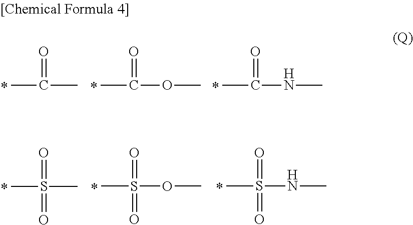

In the general formula (Q), the side with * is the linking site to the N atom that bonds to the hetero ring in the compound.

Preferably, the compound represented by the general formula (II-1) is represented by the following general formula (II-2):

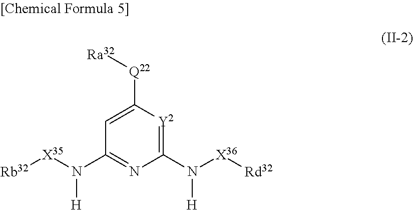

In the general formula (II-2), Y² represents a methine group, or —N—. Ra³² represents an alkyl group, an alkenyl group, an alkynyl group, an aryl group or a heterocyclic group. Rb³², Rc³² and Rd³² each independently represent a hydrogen atom, an alkyl group, an alkenyl group, an alkynyl group, an aryl group or a heterocyclic group. Q²² represents a single bond, —O—, —S—, or —NRf—; Rf represents a hydrogen atom, an alkyl group, an alkenyl group, an alkynyl group, an aryl group or a heterocyclic group, and may bond to Ra³² to form a ring. X³⁵ represents a single bond or a divalent linking group. X³⁶ represents a linking group selected from a group consisting of divalent linking groups represented by the above-mentioned general formula (Q).

More preferably, the compound represented by the general formula (II-1) is represented by the following general formula (II-4):

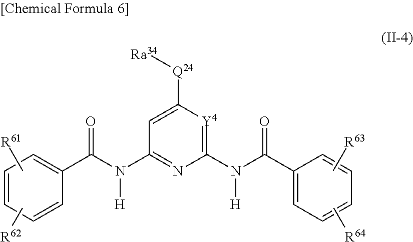

In the general formula (II-4), Y⁴ represents a methine group, or —N—. Ra³⁴ represents an alkyl group, an alkenyl group, an alkynyl group, an aryl group or a heterocyclic group. Q²⁴ represents a single bond, —O—, —S—, or —NRf—; Rf represents a hydrogen atom, an alkyl group, an alkenyl group, an alkynyl group, an aryl group or a heterocyclic group, and may bond to Ra³⁴ to form a ring. R⁶¹, R⁶², R⁶³ and R⁶⁴ each independently represent a hydrogen atom, a halogen atom, a hydroxyl group, a carbamoyl group, a sulfamoyl group, an alkyl group having from 1 to 8 carbon atoms, an alkoxy group having from 1 to 8 carbon atoms, an alkylamino group having from 1 to 8 carbon atoms, or a dialkylamino group having from 1 to 8 carbon atoms.

Even more preferably, the compound represented by the general formula (II-1) is represented by the following general formula (II-5):

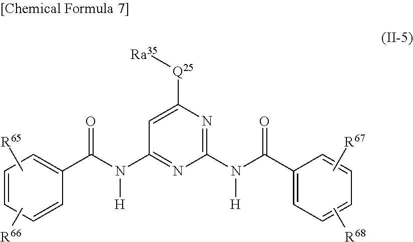

In the general formula (II-5), R⁶⁵, R⁶⁶, R⁶⁷ and R⁶⁸ each independently represent a hydrogen atom, a halogen atom, a hydroxyl group, a carbamoyl group, a sulfamoyl group, an alkyl group having from 1 to 8 carbon atoms, an alkoxy group having from 1 to 8 carbon atoms, an alkylamino group having from 1 to 8 carbon atoms, or a dialkylamino group having from 1 to 8 carbon atoms. Ra³⁵ represents an alkyl group, an alkenyl group, an alkynyl group, an aryl group or a heterocyclic group. Q²⁵ represents a single bond, —O—, —S—, or —NRf—; Rf represents a hydrogen atom, an alkyl group, an alkenyl group, an alkynyl group, an aryl group or a heterocyclic group, and may bond to Ra³⁵ to form a ring.

In the general formula (II-5), preferably, R⁶⁵, R⁶⁶, R⁶⁷ and R⁶⁸ are independently a hydrogen atom, an alkyl group having from 1 to 8 carbon atoms, or an alkoxy group having from 1 to 8 carbon atoms, more preferably a hydrogen atom, an alkyl group having from 1 to 4 carbon atoms, or an alkoxy group having from 1 to 4 carbon atoms.

Ra³⁵ is preferably an alkyl group, a hydrogen atom, an alkyl group having from 1 to 8 carbon atoms, an alkenyl group having from 2 to 8 carbon atoms, an alkynyl group having from 2 to 8 carbon atoms, an aryl group having from 6 to 18 carbon atoms (for example, a residue of a benzene ring or a naphthalene ring), or a heterocyclic group having from 4 to 10 carbon atoms (for example, a pyrrolyl group, a pyrrolidino group, a pyrazolyl group, a pyrazolidino group, an imidazolyl group, a piperazino group, a morpholino group), more preferably a hydrogen atom, or an alkyl group having from 1 to 8 carbon atoms, and even more preferably an alkyl group having from 1 to 4 carbon atoms.

Q²⁵ is preferably a single bond, a divalent linking group represented by or —O—, —S—, —N(X^{a}—Rh)-, or —N(X^{a}—Rh)—X^{b}—, in which X^{a} and X^{b} each independently represent a single bond or a divalent linking group. Examples of the divalent linking group represented by X^{a} and X^{b} include —CO—, —COO—, and —CONH—. Rh represents a hydrogen atom, an alkyl group having from 1 to 8 carbon atoms, an alkenyl group having from 2 to 8 carbon atoms, an alkynyl group having from 2 to 8 carbon atoms, an aryl group having from 6 to 10 carbon atoms, or a heterocyclic group having from 2 to 10 carbon atoms, Preferred examples of —NH-Xb- include —NH—CO—, —NH—COO—, —NH—CONH—, —NH—SO₂—, etc., and more preferred are —NH—CO— and —NH—COO—. More preferably, Q²⁵ is a single bond, or —O—, —S—, —NH— or —N(R)—, in which R is an alkyl group having from 1 to 8 carbon atoms, preferably from 1 to 4 carbon atoms; and even more preferably, Q²⁵ is a single bond or —O—.

As the retardation enhancer in the invention, also usable is a polymer additive like the above-mentioned low-molecular-weight compound. The polymer usable as the above-mentioned polycondensation ester in the invention can serve also as the retardation enhancer. As the polymer-type retardation enhancer of the polycondensation ester, preferred are the above-mentioned aromatic polyester polymers and copolymers of the aromatic polyester polymer with any other resin.

### (Other Retardation Reducer)

As the retardation reducer in the invention, widely usable are phosphate ester compounds as well as other compounds than non-phosphate compounds known as additives to cellulose acylate films.

The polymer-type retardation reducer may be selected from phosphate polyester polymers, styrenic polymers, acrylic polymers and their copolymers, and preferred are acrylic polymers and styrenic polymers. Also preferably, at least one polymer having an inherent negative birefringence such as a styrenic polymer or an acrylic polymer is contained in the retardation reducer.

As the low-molecular-weight retardation reducer of a compound except non-phosphate compounds, the following are mentioned. They may be solid or oily. Specifically, their melting point and boiling point are not specifically defined. For example, a UV-absorbing material having a melting point of not higher than 20° C. and a UV-absorbing material having a melting point of higher than 20° C. may be mixed; and different anti-aging agents may be mixed in the same manner. IR-absorbing dyes described in, for example, JP-A 2001-194522 may be used herein. The time of adding the additive may be at any time in the process of producing the cellulose ester solution (dope); or a step of adding the additive may be provided as the final step of the process of dope preparation. Further, the amount of the additive material is not specifically defined so far as the additive could exhibit its function.

The low-molecular-weight retardation reducer of a compound except non-phosphate compounds is not specifically defined. For example, its details are described in JP-A 2007-272177, [0066] to [0085].

The compounds represented by a general formula (1) in JP-A 2007-272177, [0066] to [0085] may be produced according to the following method.

The compounds of the general formula (1) in the patent publication can be produced by condensation of a sulfonyl chloride derivative and an amine derivative.

The compounds of a general formula (2) in JP-A 2007-272177 can be produced by dehydrating condensation of a carboxylic acid and an amine with a condensing agent (e.g., dicyclohexylcarbodiimide (DCC), etc.), or by substitution reaction between a carboxylic acid chloride derivative and an amine derivative.

The retardation reducer in the invention is preferably an Rth reducer as capable of realizing a favorable Nz factor. Of the retardation reducer, the Rth reducer includes, for example, acrylic polymers, styrenic polymers, and low-molecular-weight compounds of general formulae (3) to (7) in JP-A 2007-272177. Of those, preferred are acrylic polymers and styrenic polymers; and more preferred are acrylic polymers.

Preferably, the retardation reducer is added to the film in a ratio of from 0.01 to 30% by mass of the cellulose acylate, more preferably in a ratio of from 0.1 to 20% by mass, even more preferably in a ratio of from 0.1 to 10% by mass.

When the amount to be added is at most 30% by mass, the miscibility of the additive to the cellulose acylate can be enhanced and the film can be prevented from whitening. In case where two or more different types of retardation reducers are used here, the total amount thereof preferably falls within the above range.

### <Peeling Promoter>

In the second embodiment of the cellulose acylate laminate film of the invention, the skin B layer contains a peeling promoter. Having the configuration, the film secures good peelability from support in its production even though the skin B layer therein satisfies the above-mentioned formula (4).

### (Organic Acid Satisfying the Requirements (1) to (3)

Preferably, the cellulose acylate laminate film contains an organic acid satisfying the following requirements (1) to (3) in an amount of from 0.01% by mass to 20% by mass of the cellulose acylate in the skin B layer.

(1) The compound contains a structure of a polyalcohol and a polycarboxylic acid bonding via an ester bond,

(2) The total of the molecules of the polyalcohol and the polycarboxylic acid to form the compound is at least 3.

(3) The compound has at least one unsubstituted carboxyl group derived from a polycarboxylic acid.

The organic acid satisfying the requirements (1) to (3) improves the film peelability in the solution casting film formation apparatus (from the metal support on which the dope is cast) owing to the unsubstituted carboxyl group therein. In the invention, the organic acid satisfying the requirements (1) to (3) can be used as the peeling promoter.

Further, as compared with any other organic acid not containing the above-mentioned polyalcohol moiety or a hydrophobic group moiety substituting in the moiety, the organic acid of the above-mentioned type is effective for preventing metal corrosion, since the unsubstituted carboxyl group therein can adhere to the metal surface of the support and the polyalcohol moiety or the hydrophobic group moiety substituting in the moiety can block the metal surface from oxygen or the like oxidizing agent.

The organic acid satisfying the requirements (1) to (3) and usable as the peeling promoter in the cellulose acylate laminate film, and other peeling promoters also usable with the acid are described below.

The polycarboxylic acid usable in the organic acid that satisfies the requirements (1) to (3) is not specifically defined, for example, preferably including succinic acid, citric acid, tartaric acid, diacetyltartaric acid, malic acid, adipic acid.

In the organic acid satisfying the requirements (1) to (3), the number of the molecules of the polycarboxylic acid is preferably from 1 to 20, more preferably from 1 to 15, even more preferably from 1 to 10.

The polyalcohol to be used in the organic acid satisfying the requirements (1) to (3) adonitol, arabitol, ethylene glycol, diethylene glycol, triethylene glycol, tetraethylene glycol, 1,2-propanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, glycerin, etc. Of those, preferred is glycerin.

In the organic acid satisfying the requirements (1) to (3), the number of the molecules of the polyalcohol is preferably from 1 to 20, more preferably from 1 to 15, even more preferably from 1 to 10.

The organic acid satisfying the requirements (1) to (3) may have a structure in which a monoacid having a substituent with 4 or more carbon atoms forms an ester bond with a part of the hydroxyl groups in the polyalcohol therein, in addition to the polyalcohol and the polycarboxylic acid constituting the organic acid. Specific examples of the monoacid having a substituent with 4 or more carbon atoms are mentioned below. When the monoacid having a substituent with 4 or more carbon atoms is represented by RCOOH, the substituent in the monoacid having a substituent with 4 or more carbon atoms is R.

### <<Fatty Acid>>

Caproic acid, heptylic acid, caprylic acid, pelargonic acid, lauric acid, myristic acid, palmitic acid, stearic acid, oleic acid, linolic acid, linolenic acid, ricinoleic acid, undecanoic acid.

### <<Alkylsulfuric Acid>>

Myristylsulfuric acid, cetylsulfuric acid, oleylsulfuric acid.

### <<Alkylbenzenesulfonic Acid>>

Dodecylbenzenesulfonic acid, pentadecylbenzenesulfonic acid.

### <<Alkylnaphthalenesulfonic Acid>>

Sesquibutylnaphthalenesulfonic acid, diisobutylnaphthalenesulfonic acid.

Of those, preferred are fatty acids of monoacids having a substituent with 4 or more carbon atoms; more preferred are caprylic acid, lauric acid, stearic acid, oleic acid; and even more preferred is oleic acid.

In the organic acid satisfying the requirements (1) to (3), the number of the molecules of the monoacid having a substituent with 4 or more carbon atoms is preferably from 0 to 4, more preferably from 0 to 3, even more preferably from 0 to 2.

In the organic acid satisfying the requirements (1) to (3), the total number of the molecules of the polyalcohol and the polycarboxylic acid to form the compound is at least 3, preferably from 3 to 30, more preferably from 3 to 20.

In the organic acid satisfying the requirements (1) to (3), the proportion of the polycarboxylic acid, the polyalcohol and the monoacid having a substituent with 4 or more carbon atoms is not specifically defined; and in the organic acid, two or more unsubstituted hydroxyl groups may remain, or an unsubstituted hydroxyl group may remain.

The organic acid satisfying the requirements (1) to (3) has at least one polycarboxylic acid-derived unsubstituted carboxylic group, and preferably has from 1 to 40 polycarboxylic acid-derived unsubstituted carboxylic groups, more preferably from 1 to 30 polycarboxylic acid-derived unsubstituted carboxylic groups.

One alone of the organic acid satisfying the requirements (1) to (3), or two or more different types of those organic acids may be used here either singly or as combined. As the case may be, the organic acid satisfying the requirements (1) to (3) may be ionized, and may from a salt with any desired metal ion.

Preferred compound examples of the organic acid satisfying the requirements (1) to (3) for use in the invention are shown below.

Organic acids (partial condensation products of organic acids) having the composition mentioned below are preferred here. The organic acids having the composition mentioned below can be prepared, for example, using Riken Vitamin's Poem K-37V, etc.

TABLE 1

| | | | Monoacid |
|---|---|---|---|
| | | | Having |
| | | | Substituent |
| | | | with 4 or |
| | | Polycarboxylic | More Carbon |
| | Polyalcohol | Acid | Atoms |
| Organic Acid | Glycerin | Citric Acid | Oleic Acid |
| Condensation Product A-1 | 2-3 | 1-2 | 0-1 |
| Condensation Product A-2 | 2-3 | 1-2 | 1-2 |
| Condensation Product A-3 | 2-4 | 2-3 | 0-1 |
| Condensation Product A-4 | 2-4 | 2-3 | 1-2 |
| Condensation Product A-5 | 5-6 | 3-4 | 1-2 |
| Condensation Product A-6 | 7-8 | 3-4 | 1-2 |

TABLE 2

| | | | Monoacid |
|---|---|---|---|
| | | | Having |
| | | | Substituent |
| | | | with 4 or |
| | | Polycarboxylic | More |
| | Polyalcohol | Acid | Carbon Atoms |
| Organic Acid | Glycerin | Citric Acid | Caprylic Acid |
| Condensation Product B-1 | 2-3 | 1-2 | 0-1 |
| Condensation Product B-2 | 2-3 | 1-2 | 1-2 |
| Condensation Product B-3 | 2-4 | 2-3 | 0-1 |
| Condensation Product B-4 | 2-4 | 2-3 | 1-2 |
| Condensation Product B-5 | 5-6 | 3-4 | 1-2 |
| Condensation Product B-6 | 7-8 | 3-4 | 1-2 |

TABLE 3

| | | | Monoacid |
|---|---|---|---|
| | | | Having |
| | | | Substituent |
| | | | with 4 or |
| | | Polycarboxylic | More |
| | Polyalcohol | Acid | Carbon Atoms |
| Organic Acid | Glycerin | Citric Acid | Lauric Acid |
| Condensation Product C-1 | 2-3 | 1-2 | 0-1 |
| Condensation Product C-2 | 2-3 | 1-2 | 1-2 |
| Condensation Product C-3 | 2-4 | 2-3 | 0-1 |
| Condensation Product C-4 | 2-4 | 2-3 | 1-2 |
| Condensation Product C-5 | 5-6 | 3-4 | 1-2 |
| Condensation Product C-6 | 7-8 | 3-4 | 1-2 |

TABLE 4

| | | | Monoacid |
|---|---|---|---|
| | | | Having |
| | | | Substituent |
| | | | with 4 or |
| | | Polycarboxylic | More |
| | Polyalcohol | Acid | Carbon Atoms |
| Organic Acid | Glycerin | Citric Acid | Stearic Acid |
| Condensation Product D-1 | 2-3 | 1-2 | 0-1 |
| Condensation Product D-2 | 2-3 | 1-2 | 1-2 |
| Condensation Product D-3 | 2-4 | 2-3 | 0-1 |
| Condensation Product D-4 | 2-4 | 2-3 | 1-2 |
| Condensation Product D-5 | 5-6 | 3-4 | 1-2 |
| Condensation Product D-6 | 7-8 | 3-4 | 1-2 |

The amount of the organic acid satisfying the requirements (1) to (3) to be contained in the cellulose acylate laminate film may be from 0.01% by mass to 20% by mass of the resin, preferably from 0.05% by mass to 10% by mass, more preferably from 0.1% by mass to 5% by mass. In case where the organic acid satisfying the requirements (1) to (3) is in the form of a mixture of such acids, the amount thereof means the total amount of all the organic acids satisfying the requirements (1) to (3).

When the amount of the acid added is at least 0.01% by mass, then the polarizer durability enhancing effect and the peelability enhancing effect of the film could be enough.

Even though the amount added is from 0.001 to 0.01% by mass or so, the effect of the acid for enhancing the film peelability could be expected when the acid is combined with any other peelability enhancing technique of cooling the peeling site of the casting support or the like.

On the other hand, when the amount of the organic acid added is at most 20% by mass, then the acid may hardly bleed out in aging under high temperature and high humidity condition, and the cross transmittance of the polarizer comprising the film would hardly increase. Consequently, the range of the amount is favorable.

The distribution of the organic acid satisfying the requirements (1) to (3) in the cellulose acylate laminate film is not specifically defined.

Preferably, in the cellulose acylate laminate film, the concentration of the organic acid satisfying the requirements (1) to (3) in the region to the depth of 5 μm from one surface of the film and the concentration of the organic acid satisfying the requirements (1) to (3) in the region to the depth of 5 μm from the other surface of the film satisfy the following relational formula (4) from the viewpoint of preventing the molecular weight of the resin from lowering.

(4) 1.2≦(mean concentration of the organic acid in the region to the depth of 5 μm from the surface of the film having a higher concentration of the organic acid)/(mean concentration of the organic acid in the region to the depth of 5 μm from the surface of the film having a lower concentration of the organic acid)≦5.0

Preferably, the lower limit of the inequality (4) is 1.5, more preferably 2.0. The upper limit of the inequality (4) is preferably 4.5, more preferably 4.0.

### (Other Peeling Promoter)

In addition to the organic acid satisfying the requirements (1) to (3), any known peeling promoter may be added to the cellulose acylate laminate film. As the known peeling promoter, for example, preferably used here are the compounds described in JP-A 2006-45497, paragraphs [0048] to [0069].

Preferably, the peeling promoter is an organic acid, a polycarboxylate ester, a surfactant or a chelating agent.

As the polycarboxylate ester, preferably used here are the compounds described in JP-A 2006-45497, paragraph [0049].

As the surfactant, preferred are the compounds described in JP-A 2006-45497, paragraphs [0050] to [0051].

The chelating agent is a compound capable of coordinating (chelating) with a polyvalent ion such as a metal ion, for example, an iron ion, or an alkaline earth metal ion, for example, a calcium ion. As the chelating agent, usable here are the compounds described in JP-T 6-8956, and JP-A 11-190892, 2000-18038, 2010-158640, 2006-328203, 2005-68246, 2006-306969.

The total amount of all the peeling promoters to be contained in the cellulose acylate laminate film is preferably from 0.01% by mass (100 ppm) to 20% by mass (200000 ppm) of the resin, more preferably from 0.01% by mass (100 ppm) to 15% by mass (150000 ppm), even more preferably from 0.01% by mass (100 ppm) to 10% by mass (100000 ppm), still more preferably from 0.03% by mass (300 ppm) to 10% by mass (100000 ppm), further more preferably from 0.1% by mass (1000 ppm) to 5% by mass (50000 ppm).

### <Other Additives>

If desired, the cellulose acylate laminate film of the invention may suitably contain any other additives than the above-mentioned peeling promoter and retardation-controlling agent (retardation enhancer, retardation reducer), for example, an anti-aging agent, a UV absorbent, a mat agent, a lubricant, a plasticizer, etc.

### (Antiaging Agent)

In the invention, a known antiaging agent (antioxidant) may be added to the cellulose acylate solution, for example, a phenolic or hydroquinone-type antioxidant such as 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone, pentaerythrityl-tetrakis[3-(3,5-di-tert-butyl-4-hydroxyphenyl)propionate], etc. Further, also preferably used here is a phosphorus-containing antioxidant such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite, bis(2,4-di-tert-butylphenyl)pentaerythritol diphosphite, etc. The amount of the antiaging agent to be added may be from 0.05 to 5.0 parts by mass relative to 100 parts by mass of the cellulose acylate.

### (UV Absorbent)

A UV absorbent is preferably added to the cellulose acylate solution in the invention from the viewpoint of preventing deterioration of polarizer, liquid crystal, etc. The UV absorbent is preferably one having little absorption of visible light having a wavelength of at least 400 nm from the viewpoint that the compound is excellent in UV absorbability at a wavelength of 370 nm or less and has good liquid-crystal display performance. Specific examples of the UV absorbent preferably used in the invention include, for example, hindered phenol compounds, hydroxybenzophenone compounds, benzotriazole compounds, salicylate ester compounds, benzophenone compounds, cyanoacrylate compounds, nickel complex compounds, etc. Examples of the hindered phenol compounds include 2,6-di-tert-butyl-p-cresol, pentaerythrityl-tetrakis[3-(3,5-di-tert-butyl-4-hydroxyphen yl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxyenzyl)benzene, tris-(3,5-di-tert-butyl-4-hydroxybenzyl)isocyanurate, etc. Examples of the benzotriazole compound include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, (2-(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate], etc. The amount of the UV absorbent to be added is preferably from 1 ppm to 1.0% by mass in the entire optical film, more preferably from 10 to 1000 ppm.

### (Mat Agent)

Fine particles are generally added to the film of the invention for the purpose of preventing the film from being scratched in handling it or for preventing the film conveyability from worsening. The fine particles may be referred to as a mat agent, an antiblocking agent or an anti-creaking agent, and have heretofore been used in the art. They are not specifically defined so far as having the above-mentioned function. Any of a mat agent of an inorganic compound or a mat agent of an organic agent may be used here.

Preferred examples of the mat agent of an inorganic compound include silicon-containing inorganic compounds (e.g., silicon dioxide, calcined calcium silicate, hydrated calcium silicate, aluminium silicate, magnesium silicate, etc.), titanium oxide, zinc oxide, aluminium oxide, barium oxide, zirconium oxide, strontium oxide, antimony oxide, tin oxide, tin-antimony oxide, calcium carbonate, talc, clay, calcined kaolin, calcium phosphate, etc. More preferred are silicon-containing inorganic compounds and zirconium oxide. Even more preferred is silicon dioxide as capable of reducing the haze of cellulose acylate films. As fine particles of silicon dioxide, usable here are commercial products with commercial names of Aerosil R972, R974, R812, 200, 300, R202, OX50, TT600 (all by Nippon Aerosil). As fine particles of zirconium oxide, usable here are commercial products of Aerosil R976 and R811 (both by Nippon Aerosil).

Preferred examples of the mat agent of an organic compound include polymers such as silicone resins, fluororesins, acrylic resins, etc. Above all, more preferred are silicone resins. Of silicone resins, even more preferred are those having a three-dimensional network structure. For example, usable are commercial products of Tospearl 103, Tospearl 105, Tospearl 108, Tospearl 120, Tospearl 145, Tospearl 3120 and Tospearl 240 (all by Toshiba Silicone), etc.

When the mat agent is added to the cellulose acylate solution, any method is employable with no problem, capable of producing the desired cellulose acylate solution. For example, the additive may be added in the stage where a cellulose acylate is mixed with a solvent; or the additive may be added to a mixture solution prepared from a cellulose acylate and a solvent. Further, the additive may be added to and mixed with a dope just before the dope is cast, and this is a so-called direct addition method, in which the ingredients may be on-line mixed by screw kneading. Concretely, preferred is a static mixer such as an in-line mixer. As the in-line mixer, for example, preferred is a static mixer, SWJ (Toray's static tubular mixer, Hi-Mixer, by Toray Engineering). Regarding the mode of in-line addition, JP-A 2003-053752 describes an invention of a method for producing a cellulose acylate film wherein, for the purpose of preventing concentration unevenness and particle aggregation, the distance L between the nozzle tip through which an additive liquid having a composition differing from that of the main material dope is added and the start end of an in-line mixer is controlled to be at most 5 times the inner diameter d of the main material feeding line, thereby preventing concentration unevenness and aggregation of mat particles, etc. The patent reference discloses a more preferred embodiment, in which the distance (L) between the nozzle tip opening through which an additive liquid having a composition differing from that of the main material dope is added and the start end of the in-line mixer is controlled to be at most 10 times the inner diameter (d) of the feeding nozzle tip opening, and the in-line mixer is a static non-stirring tubular mixer or a dynamic stirring tubular mixer. More concretely, the patent reference discloses that the flow rate of the cellulose acylate film main material dope/in-line additive liquid is from 10/1 to 500/1, more preferably from 50/1 to 200/1. JP-A2003-014933 discloses an invention of providing a retardation film which is free from a trouble of additive bleeding and a trouble of interlayer peeling and which has good lubricity and excellent transparency; and regarding the method of adding additives to the film, the patent reference says that the additive may be added to a dissolving tank, or the additive or a solution or dispersion of the additive may be added to the dope being fed in the process of from the dissolving tank to a co-casting die, further saying that in the latter case, a mixing means such as a static mixer is provided for the purpose of enhancing the mixing efficiency therein.

Preferably, the film of the invention contains a mat agent in at least one of the skin A layer and the skin B layer for the purpose of enhancing the scratch resistance of the film by reducing the friction coefficient on the film surface, and for the purpose of preventing the film that is wide and long from being creaked and folded while it is rolled up. More preferably, a mat agent is added to both the skin A layer and the skin B layer of the film for the purpose of more effectively enhancing the scratch resistance of the film and preventing the film from being creaked.

In the film of the invention, the mat agent does not increase the haze of the film so far as a large amount of the agent is not added to the film. In fact, when the film containing a suitable amount of a mat agent is used in LCD, the film is free from disadvantages of contract reduction and bright spot formation. Not too small, the mat agent in the film can realize the creaking resistance and the scratch resistance of the film. From these viewpoints, the mat agent content is preferably from 0.01 to 5.0% by weight, more preferably from 0.03 to 3.0% by weight, even more preferably from 0.05 to 1.0% by weight.

### [Production Method for Cellulose Acylate Laminate Film]

The first embodiment of the method for producing the cellulose acylate laminate film of the invention (hereinafter this may be referred to as the production method of the invention) comprises a step of simultaneously or sequentially multi-casting a skin B layer dope that contains a cellulose acylate satisfying the following formula (2) and a core layer dope that contains a cellulose acylate satisfying the following formula (1) in that order on a support, a step of drying the multi-cast dope to give a laminate film in which the core layer derived from the core layer dope is thicker than the skin B layer derived from the skin B layer dope, and peeling the laminate film from the support, and a step of stretching the peeled laminate film, and comprises a step of adding a retardation-controlling agent having refractive index anisotropy to the skin B layer dope and the core layer dope in such a controlled manner that the amount thereof to the skin B layer dope<the amount thereof to the core layer dope.

2.00<Z1≦2.50 (1)

wherein Z1 means a total degree of acyl substitution of the cellulose acylate in the core layer.

2.50≦Z2<3.00 (2)

wherein Z2 means a total degree of acyl substitution of the cellulose acylate in the skin layer.

The second embodiment of the method for producing the cellulose acylate laminate film of the invention (hereinafter this may be referred to as the production method of the invention) comprises a step of simultaneously or sequentially multi-casting a skin B layer dope that contains a cellulose acylate satisfying the following formula (4) and a core layer dope that contains a cellulose acylate satisfying the following formula (3) in that order on a support, a step of drying the multi-cast dope to give a laminate film in which the core layer derived from the core layer dope is thicker than the skin B layer derived from the skin B layer dope, and peeling the laminate film from the support, and a step of stretching the peeled laminate film, and comprises a step of adding a retardation-controlling agent having refractive index anisotropy to the skin B layer dope and the core layer dope in such a controlled manner that the amount thereof to the skin B layer dope<the amount thereof to the core layer dope, with adding a peeling promoter to the skin B layer dope.

2.00<Z1≦2.50 (3)

wherein Z1 means a total degree of acyl substitution of the cellulose acylate in the core layer.

2.00≦Z2<2.50 (4)

wherein Z2 means a total degree of acyl substitution of the cellulose acylate in the skin B layer.

Having the configuration, the production method for the cellulose acylate laminate film of the first embodiment of the invention gives the above-mentioned cellulose acylate laminate film of the first embodiment of the invention. Also, the production method for the cellulose acylate laminate film of the second embodiment of the invention gives the above-mentioned cellulose acylate laminate film of the second embodiment of the invention.

### (Preparation of Dope)

Precisely, in the production method of the invention, a solution (dope) prepared by dissolving a cellulose acylate in an organic solvent is used to produce the film of the invention according to a solvent casting method.

Preferably, the organic solvent contains a solvent selected from ethers having from 3 to 12 carbon atoms, ketones having from 3 to 12 carbon atoms, esters having from 3 to 12 carbon atoms and halogenohydrocarbons having from 1 to 6 carbon atoms. The ether, the ketone and the ester may have a cyclic structure. A compound having at least any two of the functional groups of ether, ketone and ester (that is, —O—, —CO— and —COO—) is also usable as the organic solvent. The organic solvent may have any other functional group such as an alcoholic hydroxyl group. In a case of an organic solvent having two or more functional groups, the number of the carbon atoms constituting the compound may fall within the defined range of the compound having any of the functional groups.

Examples of the ether having from 3 to 12 carbon atoms include diisopropyl ether, dimethoxymethane, dimethoxyethane, 1,4-dioxane, 1,3-dioxolane, tetrahydrofuran, anisole and phenetol.

Examples of the ketone having from 3 to 12 carbon atoms include acetone, methyl ethyl ketone, diethyl ketone, diisopropyl ketone, cyclohexanone and methylcyclohexanone.

Examples of the ester having from 3 to 12 carbon atoms include ethyl phosphonate, propyl phosphonate, pentyl phosphonate, methyl acetate, ethyl acetate and pentyl acetate.

Examples of the organic solvent having two or more functional groups include 2-ethoxyethyl acetate, 2-methoxyethanol and 2-butoxyethanol.

Preferably, the number of the carbon atoms constituting the halogenohydrocarbon is 1 or 2, most preferably 1. Preferably, the halogen of the halogenohydrocarbons is chlorine. Preferably, the hydrogen atoms constituting the halogenohydrocarbon are substituted with halogen in a ratio of from 25 to 75 mol %, more preferably from 30 to 70%, even more preferably from 35 to 65 mol %, most preferably from 40 to 60 mol %. Methylene chloride is a typical halogenohydrocarbon.

Two or more different types of such organic solvents may be mixed for use herein.

The cellulose acylate solution can be prepared according to an ordinary method. The ordinary method is meant to include treatment at a temperature not lower than 0° C. (room temperature or high temperature). For the preparation of the solution, employable are a method and an apparatus for preparing a dope in an ordinary solvent casting method. In the ordinary method, preferably, a halogenohydrocarbon (especially methylene chloride) is used as the organic solvent.

The amount of the cellulose acylate in the solution is so controlled that the cellulose acylate could be contained in an amount of from 10 to 40% by mass in the prepared solution. More preferably, the amount of the cellulose acylate is from 10 to 30% by mass. Any additive to be mentioned may be added to the organic solvent (main solvent).

The solution may be prepared by stirring a cellulose acylate and an organic solvent at an ordinary temperature (0 to 40° C.). A high-concentration solution may be stirred under pressure and under heat. Concretely, a cellulose acylate and an organic solvent are put into a pressure container and sealed up, and stirred therein under pressure and under heat at a temperature not lower than the boiling point of the solvent at an ordinary temperature and falling within a range within which the solvent does not boil. The heating temperature is generally 40° C. or higher, preferably from 60 to 200° C., more preferably from 80 to 110° C.

The ingredients may be put into the reactor after having been previously roughly mixed. As the case may be, the ingredients may be put into the reactor in series. The reactor must be so designed that the contents therein could be stirred. An inert gas such as nitrogen gas or the like may be injected into the reactor for pressurization. As the case may be, the increase in the vapor pressure of the solvent by heating can be utilized. If desired, after the reactor has been sealed up, the ingredients may be added thereto under pressure.

Preferably, the contents are heated from outside the reactor. For example, a jacket-type heating unit may be used. If desired, a plate heater may be arranged outside the reactor, and piped, and a liquid may be circulated through the pipe to heat the whole of the reactor.

Preferably, a stirring blade is arranged inside the reactor, and the contents therein are stirred with it. Preferably, the stirring blade has a length to reach around the wall of the reactor. Preferably, a scraper is arranged at the end of the stirring blade for renewing the liquid film formed on the wall of the reactor.

The reactor may be provided with meters such as a pressure gauge, a thermometer, etc. The ingredients are dissolved in the solvent in the reactor. The prepared dope is taken out of the reactor after cooled, or after once taken out, the dope may be cooled using a heat exchanger or the like.

The solution may also be prepared according to a cooling dissolution method. According to a cooling dissolution method, a cellulose acylate can be dissolved even in an organic solvent in which the cellulose acylate is difficult to dissolve according to an ordinary dissolution method. Even in a solvent in which a cellulose acylate can be dissolved according to an ordinary dissolution method, the cooling dissolution method has an advantage in that a uniform solution can be formed rapidly.

In the cooling dissolution method, first, a cellulose acylate is gradually added to an organic solvent at room temperature with stirring. Preferably, the amount of the cellulose acylate is so controlled that it could be contained in the mixture in an amount of from 10 to 40% by mass. More preferably, the amount of the cellulose acylate is from 10 to 30% by mass. Any additive to be mentioned below may be added to the mixture.

Next, the mixture is cooled to −100 to −10° C., preferably −80 to −10° C., more preferably −50 to −20° C., most preferably −50 to −30° C. The cooling may be attained, for example, in a dry ice/methanol bath (−75° C.) or a cooled diethylene glycol solution (−30 to −20° C.). Thus cooled, the mixture of the cellulose acylate and the organic solvent solidifies.

The cooling rate is preferably at least 4° C./min, more preferably at least 8° C./min, most preferably at least 12° C./min. The cooling rate is preferably higher, but its theoretical upper limit is 10000° C./sec, its technical upper limit is 1000° C./sec, and its practical upper limit is 100° C./sec. The cooling rate is a value to be calculated by dividing the difference between the temperature at the start of cooling and the final cooling temperature by the time taken from the start of cooling to the reach to the final cooling temperature.

Further, the mixture is heated to 0 to 200° C., preferably 0 to 150° C., more preferably 0 to 120° C., most preferably 0 to 50° C., whereby the cellulose acylate dissolves in the organic solvent. For the heating, the mixture may be merely left at room temperature, or may be heated in a warm bath. The heating rate is preferably at least 4° C./min, more preferably at least 8° C./min, most preferably at least 12° C./min. The heating rate is preferably higher, but its theoretical upper limit is 10000° C./sec, its technical upper limit is 1000° C./sec, and its practical upper limit is 100° C./sec. The heating rate is a value to be calculated by dividing the difference between the temperature at the start of heating and the final heating temperature by the time taken from the start of heating to the reach to the final heating temperature.

As in the above, a uniform solution can be prepared. In case where the dissolution is insufficient, the operation of cooling and heating may be repeated. The matter whether or not the dissolution is sufficient can be determined merely by checking the outward appearance of the solution with the eye.

In the cooling dissolution method, preferably a closed reactor is used for the purpose of preventing water penetration into the solution owing to dew condensation in cooling. In cooling/heating operation, the system may be pressurized in cooling or may be depressurized in heating to shorten the dissolution time. Preferably, a pressure reactor is used for pressure increase or pressure reduction.

A 20% by mass solution prepared by dissolving a cellulose acylate (having a total degree of acetyl substitution of 60.9%, and a viscosity-average degree of polymerization of 299) in methyl acetate according to a cooling dissolution method has been known to have a pseudo-phase transition point between a sol state and a gel state at around 33° C. in differential scanning calorimetry (DSC), and is a uniform gel at a temperature not higher than that point. Accordingly, the solution must be stored at a temperature not lower than the pseudo-phase transition temperature thereof, preferably at a temperature of the gel phase transition temperature thereof plus 10° C. or so. However, the pseudo-phase transition temperature may vary depending on the total degree of acetyl substitution, the viscosity-average degree of polymerization and the solution concentration of the cellulose acylate and on the organic solvent used.

### (Co-Casting)

The prepared, two or more different types of cellulose acylate solutions (dopes) are formed into a cellulose acylate film according to a solvent casting method.

The dope is cast onto a drum or a band, and the solvent is evaporated away to form a film. Preferably, the concentration of the dope before cast is so controlled that the solid content thereof could be from 18 to 35% by mass. Preferably, the surface of the drum or the band is mirror-finished. The casting and drying method in the solvent casting method is described in U.S. Pat. Nos. 2,336,310, 2,367,603, 2,492,078, 2,492,977, 2,492,978, 2,607,704, 2,739,069, 2,739,070; BP 640731, 736892; JP-B 45-4554, 49-5614; JP-A 60-176834, 60-203430, 62-115035.

Preferably, the dope is cast on a drum or a band having a surface temperature of not higher than 10° C. After cast, preferably, the dope is dried with air for at least 2 seconds. The formed film is peeled away from the drum or band, and may be further dried at high-temperature air of which the temperature is sequentially changed from 100° C. to 160° C. to thereby evaporate away the remaining solvent. The method is described in JP-B 5-17844. According to the method, the time from casting to peeling can be shortened. For carrying out the method, the dope must be gelled at the surface temperature of the drum or band on which the dope is cast.

In the invention, the multiple prepared cellulose acylate solutions (dopes) are cast onto a smooth band or drum serving as a support for film formation thereon. The film production method of the invention is not specifically defined except for the above-mentioned matters, and any known co-casting method is applicable thereto. For example, the cellulose acylate-containing solutions may be separately cast through multiple casting mouths arranged at intervals in the running direction of the metal support and laminated to prepare a film, and, for example, the methods described in JP-A 61-158414, 1-122419 and 11-198285 are applicable thereto. The cellulose acylate solutions may be co-cast through two casting mouths to prepare a film, and, for example, the method described in JP-B 60-27562; JP-A 61-94724, 61-947245, 61-104813, 61-158413 and 6-134933 are applicable thereto. Also employable here is the casting method for a cellulose acylate film described in JP-A 56-162617, which comprises enveloping a flow of a high-viscosity cellulose acylate solution with a low-viscosity cellulose acylate solution and simultaneously extruding the high-viscosity cellulose acylate solution and the low-viscosity cellulose acylate solution for film formation. In addition, the embodiment described in JP-A 61-94724 and 61-94725 is also preferred here in which the outer side solution contains a larger amount of an alcohol ingredient of a poor solvent than in the inner side solution.

Another method employable here comprises using two casting mouths, peeling the film formed on a metal support via the first casting mouth, and casting another dope on the side of the film kept in contact with the metal support surface to thereby form a film. For example, the method is described in JP-B 44-20235. One and the same cellulose acylate solution or different types of cellulose acylate solutions may be cast with no specific limitation thereon. In order to make the formed multiple cellulose acylate layers have different functions, the cellulose acylate solutions corresponding to the intended functions may be extruded out through the casting mouths. Further, the cellulose acylate solution in the invention may be cast simultaneously with any other functional layers (for example, adhesive layer, dye layer, antistatic layer, antihalation layer, UV absorbent layer, polarizing layer, etc.). In producing the film of the invention, preferably employed is simultaneous or sequential multi-casting film formation.

In a case of using a conventional single-layer dope, a high-concentration and high-viscosity cellulose acylate solution must be extruded in order to attain the necessary film thickness; and in such a case, the stability of the cellulose acylate solution is not good and a solid may be formed to cause various problems of fish eye defect or surface flatness failure. For solving the problems, multiple cellulose acylate solutions are cast through casting mouths, whereby high-viscosity solutions can be simultaneously extruded on a metal support; and the advantages of the case are that not only films having bettered surface planarity and therefore having excellent surface condition can be produced but also high-concentration cellulose acylate solutions can be used to reduce the drying load and to increase the film production speed.

In co-casting, the thickness of the inner side layer and that of the outer side layer are not specifically defined. Preferably, the thickness of the outer side layer is from 0.2 to 50% of the total thickness, more preferably from 2 to 30%. In a case of three or more multi-casting, the total of the thickness of the metal support-side layer and the thickness of the air-side layer is defined to be the thickness of the outer layers.

In the film production method of the invention, cellulose acylate solutions are co-cast to give a cellulose acylate film having a laminate structure. For example, there can be produced a cellulose acylate film having a configuration of skin layer/core layer; and a cellulose acylate film having a configuration of skin layer/core layer/skin layer.

The first embodiment of the production method of the invention includes a step of adding a retardation-controlling agent having refractive index anisotropy to the skin B layer dope and the core layer dope in such a controlled manner that the amount thereof to the skin B layer dope<the amount thereof to the core layer dope.

The second embodiment of the production method of the invention includes a step of adding a retardation-controlling agent having refractive index anisotropy to the skin B layer dope and the core layer dope in such a controlled manner that the amount thereof to the skin B layer dope<the amount thereof to the core layer dope, with adding a peeling promoter to the skin B layer dope.

In one preferred embodiment of the production method of the invention for three-layer co-casting, a skin A layer dope is further prepared, and the amount of the refractive index anisotropy-having retardation-controlling agent to be added to each layer is so controlled that the amount thereof to the skin B layer dope<the amount thereof to the core layer dope<the amount thereof to the skin A layer dope.

In the film production method of the invention, a retardation-controlling agent is added to the core layer dope and the skin B layer dope in the manner as above, and the amount of the agent is so controlled that the amount thereof to the skin B layer dope<the amount thereof to the core layer dope, whereby the obtained film does not substantially have any refractive index anisotropy difference between the surface and the back thereof, and when the film is incorporated in a liquid-crystal display device, the device can have a high front contrast. In the invention, the amount of the retardation-controlling agent to be added to each dope concretely means the concentration of the retardation-controlling agent in each dope, which does not vary depending on the coating thickness (coating amount).

In the film of the invention, preferably, the same retardation-controlling agent is used in the core layer and the skin layer and the amount of the agent is so controlled that the amount thereof in the skin A layer dope>the amount thereof in the core layer dope>the amount thereof in the skin B layer dope, from the viewpoint of eliminating the refractive index anisotropy difference between the surface and the back of the film. Accordingly, the additive distribution in the thickness direction of the formed film could be substantially such that the distribution in the core layer=the distribution in the skin B layer, or that is, there is substantially no difference in the refractive index anisotropy between the surface and the back of the film. Further, in a case where the film of the invention is a three-layer laminate, preferably, the same retardation-controlling agent is used in the core layer and the skin layer, and the amount of the agent is so controlled that the amount thereof in the skin A layer dope>the amount thereof in the core layer dope>the amount thereof in the skin B layer dope, and the additive distribution in the thickness direction of the formed film could be substantially such that the distribution in the skin A layer=the distribution in the core layer=the distribution in the skin B layer. The reason why the additive is eccentrically located in the skin B layer is not as yet clear; however, this may be because the residual solvent amount level may vary in the film thickness direction or the additive may move to the solvent-rich layer owing to the drying rate difference between the surface side layer and the support side layer of the film.

In case where the film of the invention is a two-layer laminate, the amount of the retardation-controlling agent to be added to each layer dope is, in terms of the amount thereof relative to the cellulose acylate in each other, preferably such that the amount of the agent to be added to the core layer dope is larger by from 2.5 to 6% by mass than the amount to the skin B layer dope, more preferably by from 3 to 5% by mass, more preferably by from 3.5 to 4.5% by mass.

In case where the film of the invention is a three-layer laminate, the amount of the retardation-controlling agent to be added to each layer dope is, in terms of the amount thereof relative to the cellulose acylate in each other, preferably such that the amount of the agent to be added to the skin A layer dope is larger by from 1 to 3% by mass than the amount to the core layer dope, and the amount of the agent to be added to the core layer dope is larger by from 1 to 3% by mass than the amount to the skin B layer dope. More preferably, the amount of the agent to the skin A layer dope is larger by from 1.5 to 2.5% by mass than the amount to the core layer dope, and the amount of the agent to the core layer dope is larger by from 1.5 to 2.5% by mass than the amount to the skin B layer dope. Even more preferably, the amount of the agent to the skin A layer dope is larger by from more than 1.5% by mass to less than 2.5% by mass than the amount to the core layer dope, and the amount of the agent to the core layer dope is larger by from more than 1.5% by mass to less than 2.5% by mass than the amount to the skin B layer dope.

Preferably, in the cellulose acylate laminate film of the invention, the amount of the retardation-controlling agent in the skin B layer dope is less than 38% by mass of the cellulose acylate, and the amount of the retardation-controlling agent in the core layer dope is less than 40% by mass of the cellulose acylate, from the viewpoint of reducing the internal haze of the film to be obtained. In a preferred embodiment of the cellulose acylate laminate film of the invention having a skin A layer, the amount of the retardation-controlling agent in the skin A layer dope is preferably less than 42% by mass of the cellulose acylate for the same reason as above.

More preferably, the amount of the retardation-controlling agent added to the skin B layer dope is at most 37% by mass of the cellulose acylate, even more preferably from 15 to 30% by mass.

More preferably, the amount of the retardation-controlling agent added to the core layer dope is at most 35% by mass of the cellulose acylate, even more preferably from 12.5 to 25% by mass.

Also preferably, the amount of the retardation-controlling agent added to the skin A layer dope is at most 33% by mass of the cellulose acylate, more preferably from 10 to 20% by mass.

Regarding the other additives than the retardation-controlling agent, for example, the mat agent may be more in the skin layer or may be only in the skin layer. The plasticizer and the UV absorbent may be more in the core layer than in the skin layer, or may be only in the core layer. In the core layer and the skin layer, the type of the plasticizer and the UV absorbent may be changed. For example, low-volatile plasticizer and/or UV absorbent may be in the skin layer, while a plasticizer excellent in plasticization and a UV absorbent excellent in UV absorbability may be in the core layer. Incorporating a peeling agent only in the skin layer on the metal support side is also a preferred embodiment. For cooling the metal support in a cooling drum method to thereby gel the solution, it is also favorable to add an alcohol of a poor solvent more to the skin layer than to the core layer. Tg may differ between the skin layer and the core layer, and preferably, Tg of the core layer is lower than Tg of the skin layer. The viscosity of the cellulose acylate-containing solution to be cast may differ between the skin layer and the core layer; and preferably, the viscosity of the dope for the skin layer is lower than that for the core layer, but as the case may be, the viscosity of the dope for the core layer may be lower than the viscosity for the skin layer.

In the invention, the multi-cast dope is dried and peeled from the support.

### (Drying Step)

The method of drying the web that has been dried on the drum or the belt and peeled away from it is described. The web that has been peeled away at the peeling position just before the drum or the belt has gone round is preferably conveyed according to a method where the web is introduced alternately into rolls arranged zigzag, or according to a method where the peeled web is conveyed in a noncontact mode while held with clips on both sides thereof. The web may be dried according to a method in which air at a predetermined temperature is applied to both surfaces of the web (film) being conveyed, or according to a method of using a heating means such as microwaves, etc. Rapid drying may detract from the surface smoothness of the film to be formed, and therefore, preferably, in the initial stage of drying, the web is dried at a temperature at which the solvent does not foam, and after dried in some degree, the web is further dried at a high temperature. In the drying step after peeling from the support, the film tends to shrink in the machine direction or in the cross direction owing to evaporation of the solvent. The shrinkage may be larger when the film is dried at a higher temperature. Preferably, the film is dried with preventing the shrinkage thereof as much as possible as the surface smoothness of the formed film could be bettered more. From this viewpoint, preferred is a method where both sides of the web being dried are held with clips or pins for securing the width thereof in the cross direction in a part or all of the drying step (tenter system), for example, as shown in JP-A 62-46625. Preferably, the drying temperature in the drying step is from 100 to 145° C. The drying temperature, the drying air amount and the drying time may vary depending on the type of the solvent to be used; and the drying parameters may be suitably selected depending on the type and the combination of the solvents to be used. In producing the film of the invention, preferably, the web (film) peeled from the support is stretched while the residual solvent amount in the web is less than 120% by mass.

The residual solvent amount is represented by the following formula:

Residual Solvent Amount (% by mass)={(M−N)/N}×100,

wherein M indicates the mass of the web at an arbitrary time, and N indicates the mass of the same web after dried at 110° C. for 3 hours.

When the residual solvent amount in the web is too large, then stretching the web may be ineffective; but when too small, then stretching the web would be extremely difficult and the web may break. Amore preferred range of the residual solvent amount in the web is from 10% by mass to 50% by mass, most preferably from 12% by mass to 35% by mass. When the draw ratio in stretching is too small, then sufficient retardation could not be attained; but when too large, then stretching the web would be difficult and the web may break.

### (Stretching)

The production method of the invention includes a step of stretching the peeled film after the step of drying the multi-cast dope and peeling it from the support.

In the invention, the solution-cast film may be stretched even though it is not heated at a high temperature so far as its residual solvent amount falls within a specific range; however, stretching combined with drying is preferred as the working step may be shortened. In other words, the film may be stretched while a solvent remains therein, or may be stretched after dried. However, when the web temperature is too high, then the plasticizer may evaporate, and therefore, the temperature is preferably within a range of from room temperature (15° C.) to 145° C. Biaxial stretching in two directions perpendicular to each other is effective for making the refractive index, Nx, Ny and Nz of the film fall within the range in the invention. For example, in case where the film is stretched in the casting direction and when the film is shrunk in the cross direction too much in the case, Nz of the resulting film may be too large. In this case, the problem may be solved by decreasing the cross-direction shrinkage of the film, or by stretching the film in the cross direction. In case where the film is stretched in the cross direction, the resulting film may have refractive index distribution in the cross direction. This is often seen in a tenter method. As the film is stretched in the cross direction, the center part of the film is given a shrinking force, but the edges of the film are kept fixed. This is referred to as a bowing phenomenon. Even in such a case, the film may be stretched in the casting direction to retard the bowing phenomenon, and the retardation distribution in the cross direction of the film may be reduced. Further, the film may be stretched in two directions perpendicular to each other, whereby the film thickness fluctuation may be reduced. If an optical film has too much thickness fluctuation, it may cause retardation fluctuation. The thickness fluctuation of an optical film is preferably within a range of ±3%, more preferably within a range of ±1%. From the viewpoint as above, the method of stretching the film in two directions perpendicular to each other is effective in the invention, and the draw ratio in stretching in two directions perpendicular to each other is preferably within a range of from 1.2 to 2.0 times and from 0.7 to 1.0 time, respectively. In this, stretching in one direction in a draw ratio falling within a range of from 1.2 to 2.0 times and stretching in the other perpendicular direction in a draw ratio falling within a range of from 0.7 to 1.0 time means that the distance between the clips or pins that hold the film in stretching is made to be from 0.7 to 1.0 time relative to the distance therebetween before the stretching.

In general, in case where a film is stretched in the cross direction by from 1.2 to 2.0 times, using a biaxial stretching tenter, the film receives a force to shrink it in the perpendicular direction that is the machine direction.

Accordingly, when a film is continuously stretched by imparting thereto a force only in one direction, then its width in the perpendicular direction shrinks, and the above means a case where the shrinking amount is controlled as opposed to the case with no width control in shrinking, or that is, the distance between the clips or pins for width control is defined to fall within a range of from 0.7 to 1.0 time based on the width before stretching. In this, the film is given a force to shrink it in the machine direction owing to the force for shrinking in the cross direction. Taking the distance between the clips or the pins in the machine direction makes it possible not to give any unnecessary tension to the film in the machine direction. The method of stretching the web is not specifically defined. For example, there may be mentioned a method of using plural rolls each having a different circumferential speed and stretching a web in the machine direction between the rolls based on the difference in the circumferential speed therebetween; a method of holding both edges of a web with clips or pins and stretching the web in the machine direction by broadening the distance between the adjacent clips or pins in the machine direction, or a method of stretching the web in the cross direction by broadening the distance in the same manner but in the cross direction, or a method of stretching the web both in the machine direction and in the cross direction by broadening the distance in the same manner but in both the two directions. Needless-to-say, these methods may be combined. Specifically, the web may be stretched in the cross direction relative to the machine direction, or in the machine direction, or in both the two directions. In case of stretching the web in both the two directions, the stretching mode may be simultaneous stretching or sequential stretching. In the tenter method, the clip parts are preferably driven according to a linear drive system since the film can be smoothly stretched with little risk of breakage.

Preferably, the production method of the invention includes a second stretching step of again stretching the film after the above-mentioned stretching step, from the viewpoint of enhancing the optical expressibility of the film and broadening the optical expression range.

### [Polarizer]

As having high optical expressibility, the cellulose acylate laminate film of the invention is favorably used as a retardation film or as a polarizer protective film. A polarizer is formed by sticking a protective film on at least one surface of a polarizing film following by laminating them. As the polarizing element, any conventional one is usable here. For example, usable is a polarizing element prepared by processing a hydrophilic polymer film such as a polyvinyl alcohol film with a dichroic dye such as iodine. Sticking the cellulose acylate film to the polarizing element is not specifically defined. For example, the two may be stuck together by the use of an adhesive of an aqueous solution of a water-soluble polymer. As the water-soluble polymer adhesive, preferred is an aqueous solution of a completely saponified polyvinyl alcohol.

The film of the invention is favorably used in a configuration of polarizer protective film/polarizing element/polarizer protective film/liquid-crystal cell/film of the invention/polarizing element/polarizer protective film, or in a configuration of polarizer protective film/polarizing element/film of the invention/liquid-crystal cell/film of the invention/polarizing element/polarizer protective film. In particular, when the film of the invention is stuck to a TN-mode, VA-mode, IPS-mode of the like liquid-crystal cell, then it gives a display device excellent in viewing angle characteristics having a high front contrast and excellent in visibility.

### [Liquid-Crystal Cell]

The cellulose acylate film of the invention and the polarizer comprising the film can be used for various modes of liquid-crystals cells and in liquid-crystal display devices. Various modes of TN (twisted nematic), IPS (in-plane switching), FLC (ferroelectric liquid crystal), AFLC (anti-ferroelectric liquid crystal), OCB (optically compensatory bend), STN (supper twisted nematic), VA (vertically aligned) and HAN (hybrid aligned nematic) modes have been proposed in the art.

In another embodiment of the transmission-type liquid-crystal display device of the invention, an optical compensatory sheet comprising the film of the invention may be used as the transparent protective film for the polarizer to be arranged between the liquid-crystal cell and the polarizing element. The optical compensatory sheet may be used only on the protective film of one polarizer (between the liquid-crystal cell and the polarizing element); or the optical compensatory film may be used as the two protective films for the two polarizers (between the liquid-crystal cell and the polarizing element).

### EXAMPLES

The characteristics of the invention are described more concretely with reference to Examples and Comparative Examples given below. In the following Examples, the material used, its amount and ratio, the details of the treatment and the treatment process may be suitably modified or changed not overstepping the spirit and the scope of the invention. Accordingly, the invention should not be limitatively interpreted by the Examples mentioned below.

### (Preparation of Cellulose Acylate)

According to the method described in JP-A 10-45804 and 08-231761, a cellulose acylate was produced, and its degree of substitution was measured. Concretely, as a catalyst, sulfuric acid was added in an amount of 7.8 parts by mass relative to 100 parts by mass of cellulose, and a carboxylic acid as a material for the acyl substituent group was added for acylation at 40° C. In this process, the type and the amount of the carboxylic acid were controlled to thereby control the type and the degree of acyl substitution. After the acylation, the product was ripened at 40° C. The low-molecular-weight ingredient of the cellulose acylate was washed away with acetone.

### Production Example 1

### Production of Dope

### (Preparation of Dope Solution A1)

The following composition was put into a mixing tank and stirred to dissolve the ingredients, thereby preparing a cellulose acetate solution (hereinafter this may be referred to as dope solution). The obtained dope solution is called dope solution A1.

| | |
|---|---|
| Cellulose acetate (degree of substitution 2.44) | 100.0 mas. pts. |
| Exemplary Compound 1 | 20.0 mas. pts. |
| Methylene chloride | 365.0 mas. pts. |
| Methanol | 55.0 mas. pts. |

The solid concentration was 22.2% by mass and the cellulose acetate concentration was 18.5% by mass.

### Production Example 2

### Preparation of Dope Solution B1

The following composition was put into a mixing tank and stirred to dissolve the ingredients, thereby preparing a dope solution B1.

| | |
|---|---|
| Cellulose acetate (degree of substitution 2.44) | 100.0 mas. pts. |
| Exemplary Compound 1 | 15.0 mas. pts. |
| Peeling Promoter | 1.0 mas. pt. |
| Methylene chloride | 366.0 mas. pts. |
| Methanol | 55.0 mas. pts. |

The solid concentration was 22.4% by mass and the cellulose acetate concentration was 18.5% by mass.

### Production Example 3

### Preparation of Dope Solution C1

The following composition was put into a mixing tank and stirred to dissolve the ingredients, thereby preparing a dope solution C1.

| | |
|---|---|
| Cellulose acylate (cellulose acetate propionate, | 100.0 mas. pts. |
| having a degree of acetyl substitution of 1.8 and | |
| a degree of propionyl substitution of 0.7 | |
| Exemplary Compound 2 | 30.0 mas. pts. |
| Tinuvin 109 (by Ciba Specialty Chemicals) | 1.8 mas. pts. |
| Tinuvin 171 (by Ciba Specialty Chemicals) | 0.8 mas. pts. |
| Methylene chloride | 411.0 mas. pts. |
| Ethanol | 83.0 mas. pts. |

The solid concentration was 21.7% by mass and the cellulose acetate propionate concentration was 15.9% by mass.

### Production Example 4

### Preparation of Dope Solution D1

The following composition was put into a mixing tank and stirred to dissolve the ingredients, thereby preparing a dope solution D1.

| | |
|---|---|
| Cellulose acetate (degree of substitution 2.81) | 100.0 mas. pts. |
| Exemplary Compound 1 | 20.0 mas. pts. |
| Methylene chloride | 388.0 mas. pts. |
| Methanol | 58.0 mas. pts. |

The solid concentration was 19.8% by mass and the cellulose acetate concentration was 18.0% by mass.

### Production Example 5

Dope solutions shown in Table 5 below were prepared in the same manner as that for the dope solutions A1, B, C1 and D1 except that the cellulose acetate and the additive and their amount were changed as in Table 5. In every changed case, the amount of the solvent was suitably so controlled that the cellulose acetate concentration and the solvent composition therein could be the same as those in the unchanged dope solutions.

TABLE 5

| Cellulose | | | | |
|---|---|---|---|---|
| Acetate | Degree of | Additive | | |
| Dope | Acyl | | Amount | Unchanged |
| Solution | Substitution | Compound | Added | Solution |
| A1 | 2.44 | Exemplary Compound 1 | 20.0 | — |
| B1 | 2.44 | Exemplary Compound 1 | 15.0 | — |
| B1-2 | 2.44 | Exemplary Compound 1 | 14.0 | B1 |
| B1-3 | 2.44 | Exemplary Compound 1 | 16.0 | B1 |
| B1-4 | 2.44 | Exemplary Compound 1 | 17.0 | B1 |
| B1-5 | 2.44 | Exemplary Compound 1 | 18.0 | B1 |
| B1-6 | 2.44 | Exemplary Compound 1 | 20.0 | B1 |
| C1 | 2.5 | Exemplary Compound 2 | 30.0 | — |
| C1-2 | 2.5 | Exemplary Compound 2 | 32.0 | Cl |
| C1-3 | 2.5 | Exemplary Compound 2 | 26.0 | Cl |
| C1-4 | 2.5 | Exemplary Compound 2 | 28.0 | Cl |
| D1 | 2.82 | Exemplary Compound 1 | 20.0 | — |
| D1-2 | 2.82 | Exemplary Compound 1 | 14.0 | D1 |
| D1-3 | 2.82 | Exemplary Compound 1 | 15.0 | D1 |
| D1-4 | 2.82 | Exemplary Compound 1 | 16.0 | D1 |
| D1-5 | 2.82 | Exemplary Compound 1 | 17.0 | D1 |
| D1-6 | 2.82 | Exemplary Compound 1 | 17.5 | D1 |
| D1-7 | 2.82 | Exemplary Compound 1 | 18.0 | D1 |
| D1-8 | 2.82 | Exemplary Compound 1 | 18.5 | D1 |
| D1-9 | 2.82 | Exemplary Compound 1 | 19.0 | D1 |
| D1-10 | 2.82 | Exemplary Compound 1 | 21.0 | D1 |
| D1-11 | 2.82 | Exemplary Compound 1 | 21.5 | D1 |
| D1-12 | 2.82 | Exemplary Compound 1 | 22.0 | D1 |
| D1-13 | 2.82 | Exemplary Compound 1 | 22.5 | D1 |
| D1-14 | 2.82 | Exemplary Compound 1 | 23.0 | D1 |

The peeling promoter, the exemplary compound 1 and the exemplary compound 2 used in the dope solutions in Production Examples 1 to 5 are the following additives.

### Peeling Promoter

The condensation product A-2 shown in Table 1 (trade name, Poem K-37V, by Riken Vitamin) was used.

### Exemplary Compound 1

Terephthalic acid/succinic acid/propylene glycol/ethylene glycol copolymer (copolymerization ratio [mol %]=27.5/22.5/25/25), having Mw=730.

The exemplary compound 1 is a retardation enhancer, and is end-capped with an acetyl group.

### Exemplary Compound 2

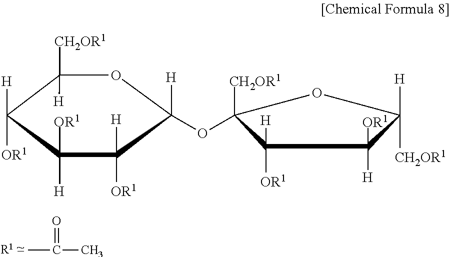

### Production Example 6

### Preparation of Dope Solution D1M

The following composition was put into a mixing tank and stirred to dissolve the ingredients, thereby preparing a mat agent dispersion MD1.

| | |
|---|---|
| Silica particles having a mean particle size of 20 nm, | 2.0 mas. pts. |
| “AEROSIL R972” by Nippon Aerosil | |
| Methylene chloride | 76.1 mas. pts. |
| Methanol | 11.4 mas. pts. |
| Dope solution D1 | 12.6 mas. pts. |

The dope solution D1 prepared in Production Example 4 was mixed with the above-prepared mat agent dispersion MD1 in a ratio mentioned below, thereby preparing a dope solution D1M comprising the dope solution D1 with a mat agent added thereto.

| | | |
|---|---|---|
| Dope solution D1 | 100.0 | mas.pts. |
| Mat agent dispersion MD1 | 7.1 | mas.pts. |

### Production Example 7

### Preparation of Dope Solutions D1-2M to D1-16M, B1-M, B1-2M to B1-6M, C1-M, C1-2M to C1-4M

Mat agent dispersions MD-1-2 to 16, MB1, MB1-2 to MB1-6, MC1, MC1-2 to MC1-4 were prepared in the same manner as that for the mat agent dispersion MD1 except that, in Production Example 6, the dope solution D1 was changed to any of the dope solutions D1-2 to 16, B1, B1-2 to B1-6, C1, and C1-2 to C1-4 prepared in Production Examples 1 to 3 and 5.

Dope solutions D1-2M to D1-16M, B1-M, B1-2M to B1-6M, C1-M, C1-2M to C1-4M were prepared in the same manner as that for the dope solution D1M except that, in Production Example 6, the mat agent dispersion MD1 was changed to any of the mat agent dispersion MD1-2 to 16, MB1, MB1-2 to MB1-6, MC1, MC1-2 to MC1-4 prepared in the above.

### Examples 1 to 17 and Comparative Examples 1 to 5

### Production of Cellulose Acylate Laminate Film

### (Casting)

Of the dope solutions prepared in the above-mentioned Production Examples 1 to 7, A1, A1-2, B1-M, B1-2M to B1-6M, C1, C1M, C1-2M to C1-4M, D1M, D1-2M to D1-16M, the dope solution in Table 6 below of Examples and Comparative Examples was cast using a band caster.

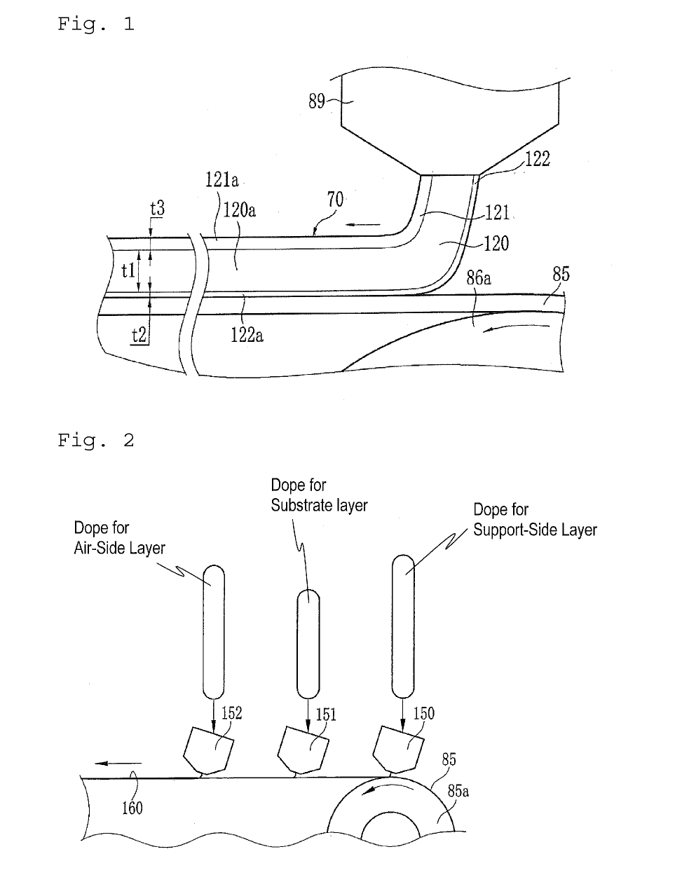

In casting the dope solution, the dopes shown in Table 6 below were co-cast through the casting die 89 onto the running band 85 as in FIG. 1, in the manner shown in FIG. 2. In this, the casting amount of each dope was so controlled that the core layer could be the thickest to give the cast film 70 in a mode of simultaneous multilayer casting and that the stretched film could have the thickness as shown in Table 6 below.

TABLE 6

| | Core Layer | | Skin B Layer | | Skin A Later | |
|---|---|---|---|---|---|---|
| | Dope | Thick- | Dope | Thick- | Dope | Thick- |
| | Solution | ness | Solution | ness | Solution | ness |
| | type | [μm] | type | [μm] | type | [μm] |
| Example 1 | A1 | 54 | D1-4M | 2 | — | — |
| Example 2 | A1 | 54 | D1-5M | 2 | — | — |
| Example 3 | A1 | 54 | D1-3M | 2 | — | — |
| Example 4 | A1 | 54 | D1-7M | 2 | — | — |
| Example 5 | A1 | 54 | D1-2M | 2 | — | — |
| Comparative | A1 | 54 | D1M | 2 | — | — |
| Example 1 | | | | | | |
| Example 6 | A1 | 54 | D1-7M | 2 | D1-12M | 2 |
| Example 7 | A1 | 54 | D1-8M | 2 | D1-11M | 2 |
| Example 8 | A1 | 54 | D1-6M | 2 | D1-13M | 2 |
| Example 9 | A1 | 54 | D1-9M | 2 | D1-10M | 2 |
| Example 10 | A1 | 54 | D1-5M | 2 | D1-14M | 2 |
| Comparative | A1 | 54 | D1M | 2 | D1M | 2 |
| Example 2 | | | | | | |
| Example 11 | A1 | 54 | B1-3M | 2 | — | — |
| Example 12 | A1 | 54 | B1-4M | 2 | — | — |
| Example 13 | A1 | 54 | B1-M | 2 | — | — |
| Example 14 | A1 | 54 | B1-5M | 2 | — | — |
| Example 15 | A1 | 54 | B1-2M | 2 | — | — |
| Comparative | A1 | 54 | B1-6M | 2 | — | — |
| Example 3 | | | | | | |
| Example 16 | C1 | 54 | C1-3M | 2 | — | — |
| Example 17 | C1 | 54 | C1-4M | 2 | C1-2M | |
| Comparative | C1 | 54 | C1M | 2 | — | — |
| Example 4 | | | | | | |
| Comparative | C1 | 54 | C1M | 2 | C1M | |
| Example 5 | | | | | | |

Next, the cast film 70 was peeled from the casting band 85 to be a wet film, and then dried in the transfer zone and in the tenter to be a dry film. The film was transferred to a drying chamber and well dried while conveyed as hung around a large number of rollers therein. During this, the film was stretched in the machine direction (MD) while conveyed.

Finally, the film was wound up around a winding roller in a winding chamber to be an MD-stretched film. The remaining solvent amount in the dope film immediately after peeled from the band was about 30% by mass.

### (Second Stretching)

After MD-stretched, the film was stretched by 30% in the transverse direction (TD) perpendicular to the machine direction, using a tenter, and then relaxed at 140° C. for 60 seconds to give a cellulose acylate laminate film of Examples and Comparative Examples. The thickness of the cellulose acylate laminate film of Examples and Comparative Examples is shown in the above Table 6.

### <Evaluation of Physical Properties of Cellulose Acylate Laminate Films of Examples and Comparative Examples>

The properties of the cellulose acylate laminate films of Examples and Comparative Examples were determined according to the methods described below. The results are shown in Table 7 below.

### (Retardation of Film)

According to the above-mentioned method, the film was analyzed with an automatic birefringence meter (KOBRA-21ADH, by Oji Scientific Instruments).

### (Refractive Index Anisotropy of the Surface and the Back of Film)

The produced cellulose acylate laminate film was analyzed according to the above-mentioned method to determine Δn of both sides of the film (the skin B layer side and the core layer side in the two-layer laminate, the skin B layer side and the skin A layer side in the three-layer laminate). Based on the thus-calculated values Δn, the difference between the surface and the back was calculated by subtracting the value Δn on the core layer side from the value Δn on the skin B layer side in the two-layer laminate, and by subtracting the value Δn on the skin A layer side from the value Δn on the skin B layer side in the three-layer laminate.

### (Internal Haze of Film)

According to the above-mentioned method, the internal haze of the produced cellulose acylate laminate film was measured.

TABLE 7

| | Optical | | Refractive Index Anisotropy | | | |
|---|---|---|---|---|---|---|
| | Characteristics | | Measured on the | Measured on the | Difference between the | Internal |
| | Re | Rth | skin B layer side | skin A layer side | surface and the back | Haze |
| | [nm] | [μm] | Δn | Δn | Surface/Back Δn | [%] |
| Example 1 | 50 | 120 | 0.0026 | 0.0025 | 0.0001 | 0.04 |
| Example 2 | 50 | 120 | 0.0026 | 0.0024 | 0.0002 | 0.04 |
| Example 3 | 50 | 120 | 0.0024 | 0.0026 | −0.0002 | 0.04 |
| Example 4 | 50 | 120 | 0.0027 | 0.0023 | 0.0004 | 0.04 |
| Example 5 | 50 | 120 | 0.0023 | 0.0027 | −0.0004 | 0.04 |
| Comparative | 50 | 120 | 0.0030 | 0.0020 | 0.0010 | 0.04 |
| Example 1 | | | | | | |
| Example 6 | 50 | 120 | 0.00255 | 0.00245 | 0.0001 | 0.04 |
| Example 7 | 50 | 120 | 0.00260 | 0.00240 | 0.0002 | 0.04 |
| Example 8 | 50 | 120 | 0.00240 | 0.00260 | −0.0002 | 0.04 |
| Example 9 | 50 | 120 | 0.00270 | 0.00230 | 0.0004 | 0.04 |
| Example 10 | 50 | 120 | 0.00230 | 0.00270 | −0.0004 | 0.04 |
| Comparative | 50 | 120 | 0.00300 | 0.00200 | 0.0010 | 0.04 |
| Example 2 | | | | | | |
| Example 11 | 50 | 120 | 0.00255 | 0.00245 | 0.0001 | 0.04 |
| Example 12 | 50 | 120 | 0.00260 | 0.00240 | 0.0002 | 0.04 |
| Example 13 | 50 | 120 | 0.00240 | 0.00260 | −0.0002 | 0.04 |
| Example 14 | 50 | 120 | 0.00270 | 0.00230 | 0.0004 | 0.04 |
| Example 15 | 50 | 120 | 0.00230 | 0.00270 | −0.0004 | 0.04 |
| Comparative | 50 | 120 | 0.00300 | 0.00200 | 0.0010 | 0.04 |
| Example 3 | | | | | | |
| Example 16 | 50 | 120 | 0.00255 | 0.00245 | 0.0001 | 0.04 |
| Example 17 | 50 | 120 | 0.00255 | 0.00245 | 0.0001 | 0.04 |
| Comparative | 50 | 120 | 0.00300 | 0.00200 | 0.0010 | 0.04 |
| Example 4 | | | | | | |
| Comparative | 50 | 120 | 0.00300 | 0.00200 | 0.0010 | 0.04 |
| Example 5 | | | | | | |

### <Production of Polarizer Sample>

The surface of the cellulose acylate laminate film of Examples and Comparative Examples produced in the above was alkali-saponified. Briefly, the film was dipped in an aqueous 1.5 N sodium hydroxide solution at 45° C. for 2 minutes, then washed in a washing bath at room temperature, and neutralized with 0.1 N sulfuric acid at 30° C. Again this was washed in a washing bath at room temperature, and dried with hot air at 100° C. On the other hand, a roll of polyvinyl alcohol film having a thickness of 80 μm was unrolled and continuously stretched by 5 times in an aqueous iodine solution, and dried to give a polarizing element having a thickness of 20 μm. Using an aqueous 3% solution of polyvinyl alcohol (Kuraray's PVA-117H) serving as an adhesive, the alkali-saponified cellulose acylate laminate film sample of Examples and Comparative Examples was stuck to a film of Fujitac TD80UL (by FUJIFILM) that had been alkali-saponified in the same manner as above, with the polarizing element sandwiched therebetween and with the saponified faces of the two films kept facing each other, thereby constructing a polarizer in which the cellulose acylate laminate film of Examples and Comparative Examples and TD80UL served as protective films for the polarizing element. In this, the MD direction of the cellulose acylate laminate film and the slow axis of TD80UL were kept in parallel to the absorption axis of the polarizing element. Thus, polarizers of Examples and Comparative Examples were produced.

### <Production of Liquid-Crystal Display Device>

Two polarizers of Examples and Comparative Examples were stuck to a VA-mode liquid-crystal cell in such a manner that the cellulose acylate laminate film of Examples and Comparative Examples could face the liquid-crystal cell and that the absorption axes of the polarizer could be perpendicular to each other, thereby constructing a liquid-crystal display device of Examples and Comparative Examples. The VA-mode liquid-crystal cell used here was one prepared by peeling the polarizer and the retardation plate on both the surface and the back of a VA-mode liquid-crystal TV (LC46-LV3, by Sharp).

### <Evaluation of Liquid-Crystal Display Device>

### (Front Contrast of Panel)

The liquid-crystal display device produced in Examples and Comparative Examples was tested for the transmittance in the front direction (in the normal direction to the display panel) thereof at the time of black level and white level of display, using BM-5A (by Topcon), thereby determining the front contrast of the device. The results are shown in Table 8 below.

TABLE 8

| | Liquid-Crystal | | Liquid- | | | Front Contrast, as |
|---|---|---|---|---|---|---|
| | display | Panel Side | Crystal | Light Source | Front | standardized from |
| | Device No. | Film | Cell | Side Film | Contrast | Example 1, 100 |
| Example 1 | 1 | Example 1 | VA | Example 1 | 4800 | 100 |
| Example 2 | 2 | Example 2 | VA | Example 2 | 4656 | 97 |
| Example 3 | 3 | Example 3 | VA | Example 3 | 4656 | 97 |
| Example 4 | 4 | Example 4 | VA | Example 4 | 4560 | 95 |
| Example 5 | 5 | Example 5 | VA | Example 5 | 4423 | 95 |
| Comparative | 6 | Comparative | VA | Comparative | 4272 | 88 |
| Example 1 | | Example 1 | | Example 1 | | |
| Example 6 | 7 | Example 6 | VA | Example 6 | 4750 | 99 |
| Example 7 | 8 | Example 7 | VA | Example 7 | 4608 | 96 |
| Example 8 | 9 | Example 8 | VA | Example 8 | 4608 | 96 |
| Example 9 | 10 | Example 9 | VA | Example 9 | 4513 | 94 |
| Example 10 | 11 | Example 10 | VA | Example 10 | 4513 | 94 |
| Comparative | 12 | Comparative | VA | Comparative | 4228 | 87 |
| Example 2 | | Example 2 | | Example 2 | | |
| Example 11 | 14 | Example 11 | VA | Example 11 | 4800 | 100 |
| Example 12 | 15 | Example 12 | VA | Example 12 | 4632 | 96 |
| Example 13 | 16 | Example 13 | VA | Example 13 | 4632 | 96 |
| Example 14 | 17 | Example 14 | VA | Example 14 | 4536 | 94 |
| Example 15 | 18 | Example 15 | VA | Example 15 | 4536 | 94 |
| Comparative | 19 | Comparative | VA | Comparative | 4224 | 87 |
| Example 3 | | Example 3 | | Example 3 | | |
| Example 16 | 20 | Example 16 | VA | Example 16 | 4750 | 99 |
| Example 17 | 21 | Example 17 | VA | Example 17 | 4750 | 99 |
| Comparative | 22 | Comparative | VA | Comparative | 4200 | 85 |
| Example 4 | | Example 4 | | Example 4 | | |
| Comparative | 23 | Comparative | VA | Comparative | 4200 | 85 |
| Example 5 | | Example 5 | | Example 5 | | |

From the above Tables 5 to 8, it is known that the liquid-crystal display devices each having the polarizer that comprises the cellulose acylate laminate film of Examples all have a high front contrast. On the other hand, it is known that the liquid-crystal display devices where the polarizer used comprises a cellulose acylate laminate film of which the refractive index anisotropy of the surface and the back oversteps the upper limit of the range of the invention have a low front contrast.

The present disclosure relates to the subject matter contained in Japanese Patent Application No. 2011-216029, filed on Sep. 30, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose acylate laminate film containing at least one skin B layer that contains a cellulose acetate satisfying the following formula (2) or (4) and a core layer that is thicker than the skin B layer and contains a cellulose acylate satisfying the following formula (1), wherein the core layer and the skin B layer contain a retardation-controlling agent having refractive index anisotropy and the difference between the refractive index anisotropy measured on one surface of the film and the refractive index anisotropy measured on the other surface thereof is at most 0.0005, provided that when at least one skin B layer contains a cellulose acetate satisfying the formula (4), the skin B layer contains a peeling promoter:
2.00<Z1≦2.50 (1)
wherein Z1 means a total degree of acyl substitution of the cellulose acylate in the core layer,
2.50≦Z2<3.00 (2)
2.00<Z2<2.50 (4)
wherein Z2 means a total degree of acyl substitution of the cellulose acylate in the skin B layer.

2. The cellulose acylate laminate film according to claim 1, wherein at least one skin B layer contains a cellulose acetate satisfying the formula (2).

3. The cellulose acylate laminate film according to claim 1, wherein at least one skin B layer contains a cellulose acetate satisfying the formula (4) and a peeling promoter.

4. The cellulose acylate laminate film according to claim 1, wherein the skin B layer is only formed on one surface of the core layer, and a skin A layer that contains a cellulose acylate satisfying the following formula (5) is formed on the surface of the core layer opposite to the surface having the skin B layer:
2.50≦Z3<3.00 (5)
wherein Z3 means a total degree of acyl substitution of the cellulose acylate in the skin A layer.

5. The cellulose acylate laminate film according to claim 1, wherein the in-plane retardation Re of the cellulose acylate laminate film at a measuring wavelength of 590 nm satisfies 25 nm≦|Re|≦100 nm and the thickness-direction retardation Rth of the cellulose acylate laminate film satisfies 50 nm≦|Rth|≦250 nm.

6. The cellulose acylate laminate film according to claim 1, wherein the core layer has a mean thickness of from 30 to 100 μm.

7. The cellulose acylate laminate film according to claim 1, wherein the skin B layer has a mean thickness of from 0.2% to less than 25% of the mean thickness of the core layer.

8. The cellulose acylate laminate film according to claim 1, which has an internal haze of at most 0.08%.

9. A method for producing a cellulose acylate laminate film, which comprises simultaneously or sequentially multi-casting a skin B layer dope that contains a cellulose acylate satisfying the following formula (2) or (4) and a core layer dope that contains a cellulose acylate satisfying the following formula (1) in that order on a support, drying the multi-cast dope to give a laminate film in which the core layer derived from the core layer dope is thicker than the skin B layer derived from the skin B layer dope, and peeling the laminate film from the support, and stretching the peeled laminate film, wherein a retardation-controlling agent having refractive index anisotropy is contained in the skin B layer dope and the core layer dope in such a controlled manner that the amount of the retardation-controlling agent to the skin B layer dope<the amount of the retardation-controlling agent to the core layer dope, provided that when the skin B layer dope contains a cellulose acylate satisfying the formula (4), the skin B layer dope also contains a peeling promoter:
2.00<Z1≦2.50 (1)
wherein Z1 means a total degree of acyl substitution of the cellulose acylate in the core layer,
2.50≦Z2<3.00 (2)
2.00≦Z2<2.50 (4)
wherein Z2 means a total degree of acyl substitution of the cellulose acylate in the skin B layer.

10. The method for producing a cellulose acylate laminate film according to claim 9, wherein the skin B layer dope contains a cellulose acylate satisfying the formula (2).

11. The method for producing a cellulose acylate laminate film according to claim 9, wherein the skin B layer dope contains a cellulose acylate satisfying the formula (4) and a peeling promoter.

12. The method for producing a cellulose acylate laminate film according to claim 9, wherein a skin A layer dope that contains a cellulose acylate satisfying the following formula (5) is further multi-cast on the core layer dope, then the multi-cast dope is dried to give a laminate film in which the core layer derived from the core layer dope is thicker than the skin A layer derived from the skin A layer dope, and a retardation-controlling agent having refractive index anisotropy is contained in the skin B layer dope, the core layer dope and the skin A layer dope in such a controlled manner that the amount of the retardation-controlling agent to the skin B layer dope<the amount of the retardation-controlling agent to the core layer dope<the amount of the retardation-controlling agent to the skin A layer dope.
2.50≦Z3<3.00 (5)
wherein Z3 means a total degree of acyl substitution of the cellulose acylate in the skin A layer.

13. The method for producing a cellulose acylate laminate film according to claim 9, wherein the retardation-controlling agent is contained in the core layer dope in an mount of less than 40% by mass of the cellulose acylate in the dope.

14. The method for producing a cellulose acylate laminate film according to claim 9, wherein the retardation-controlling agent is contained in the skin B layer dope in an amount of less than 38% by mass of the cellulose acylate in the dope.

15. The method for producing a cellulose acylate laminate film according to claim 9, further comprising secondly stretching the film after the stretching of the peeled film.

16. A cellulose acylate laminate film produced by simultaneously or sequentially multi-casting a skin B layer dope that contains a cellulose acylate satisfying the following formula (2) or (4) and a core layer dope that contains a cellulose acylate satisfying the following formula (1) in that order on a support, drying the multi-cast dope to give a laminate film in which the core layer derived from the core layer dope is thicker than the skin B layer derived from the skin B layer dope, and peeling the laminate film from the support, and stretching the peeled laminate film, wherein a retardation-controlling agent having refractive index anisotropy is contained in the skin B layer dope and the core layer dope in such a controlled manner that the amount of the retardation-controlling agent to the skin B layer dope<the amount of the retardation-controlling agent to the core layer dope, provided that when the skin B layer dope contains a cellulose acylate satisfying the formula (4), the skin B layer dope also contains a peeling promoter:
2.00<Z1≦2.50 (1)
wherein Z1 means a total degree of acyl substitution of the cellulose acylate in the core layer,
2.50≦Z2<3.00 (2)
2.00≦Z2<2.50 (4)
wherein Z2 means a total degree of acyl substitution of the cellulose acylate in the skin B layer.

17. The cellulose acylate laminate film according to claim 16, wherein the skin B layer dope contains a cellulose acylate satisfying the formula (2).

18. The cellulose acylate laminate film according to claim 16, wherein the skin B layer dope contains a cellulose acylate satisfying the formula (4) and a peeling promoter.

19. A polarizer comprising at least one cellulose acylate laminate film containing at least one skin B layer that contains a cellulose acetate satisfying the following formula (2) or (4) and a core layer that is thicker than the skin B layer and contains a cellulose acylate satisfying the following formula (1), wherein the core layer and the skin B layer contain a retardation-controlling agent having refractive index anisotropy and the difference between the refractive index anisotropy measured on one surface of the film and the refractive index anisotropy measured on the other surface thereof is at most 0.0005, provided that when at least one skin B layer contains a cellulose acetate satisfying the formula (4), the skin B layer contains a peeling promoter:
2.00<Z1≦2.50 (1)
wherein Z1 means a total degree of acyl substitution of the cellulose acylate in the core layer,
2.50≦Z2<3.00 (2)
2.00<Z2<2.50 (4)
wherein Z2 means a total degree of acyl substitution of the cellulose acylate in the skin B layer.

20. A liquid-crystal display device comprising at least one cellulose acylate laminate film containing at least one skin B layer that contains a cellulose acetate satisfying the following formula (2) or (4) and a core layer that is thicker than the skin B layer and contains a cellulose acylate satisfying the following formula (1), wherein the core layer and the skin B layer contain a retardation-controlling agent having refractive index anisotropy and the difference between the refractive index anisotropy measured on one surface of the film and the refractive index anisotropy measured on the other surface thereof is at most 0.0005, provided that when at least one skin B layer contains a cellulose acetate satisfying the formula (4), the skin B layer contains a peeling promoter:
2.00<Z1≦2.50 (1)
wherein Z1 means a total degree of acyl substitution of the cellulose acylate in the core layer,
2.50≦Z2<3.00 (2)
2.00<Z2<2.50 (4)
wherein Z2 means a total degree of acyl substitution of the cellulose acylate in the skin B layer.
